(19) United States
(12) Patent Application Publication
(10) Pub. No.: US 2026/0328913 A1
(43) Pub. Date: Oct. 22, 2026

(54) RANGING DEVICE AND RANGING METHOD

(71) Applicant: CANON KABUSHIKI KAISHA, Tokyo (JP)

(72) Inventors: KAZUYA KAYAMA, Tokyo (JP); KAZUMA CHIDA, Kanagawa (JP)

(21) Appl. No.: 19/651,399

(22) Filed: Apr. 17, 2026

(30) Foreign Application Priority Data
Apr. 22, 2025 (JP) 2025-070335

(51) Int. Cl. G01S 7/486; G01S 7/4863; G01S 17/10; G01S 17/931

(52) U.S. Cl. CPC G01S 7/4868; G01S 7/4863; G01S 17/10; G01S 17/931

(57) ABSTRACT

A ranging device includes a light receiving unit that outputs a micro-frame having a one-bit signal indicating presence or absence of incident light at a predetermined timing to a photoelectric conversion element, an addition unit that adds signal values of a plurality of the micro-frames output from the light receiving unit each for micro-frames that are based on the incident light at a same timing, and to generate a plurality of sub-frames each having a multi-bit signal acquired by adding signal values of two or more of the micro-frames, a determination unit that performs a determination to change or not change an operation condition of the light receiving unit or the addition unit based on signal values of the plurality of sub-frames, and a control unit configured to control the operation condition according to a determination result by the determination unit.

### BACKGROUND

### Field of the Technology

The present disclosure relates to a ranging device and a ranging method.

### Description of the Related Art

Japanese Patent Laid-Open No. 2024-057740 describes a ranging device that measures a distance to an object by applying a time-of-flight (ToF) method to a photon detection sensor using a single photon avalanche diode (SPAD) element. In the ranging method described in Japanese Patent Laid-Open No. 2024-057740, pulsed light that repeatedly emits light at a predetermined frequency is irradiated onto an object, and the reflected light from the object is detected with synchronizing the irradiation of the pulsed light and the detection by the SPAD sensor with each other. That is, a specific exposure period (hereinafter, referred to as a gating period) is set in association with the emission timing of the pulsed light in the SPAD sensor, and photon detection is performed in the exposure period. Then, the gating period is sequentially shifted, and a signal corresponding to each of the plurality of gating periods is acquired. This result is recorded in the histogram memory and the distance to the object is calculated from the histogram peak. Further, Japanese Patent Laid-Open No. 2018-182051 describes a photodetection device configured to prevent a processing circuit from becoming saturated by adjusting sensitivity of a light receiving unit according to a measured amount of light.

However, in the ranging device described in Japanese Patent Laid-Open No. 2024-057740, a sufficient study has not been made on a decrease in ranging accuracy due to saturation of signal values. In addition, the time gate type ranging device described in Japanese Patent Laid-Open No. 2024-057740 is configured to detect whether or not a photon is detected during a gating period, and the technique described in Japanese Patent Laid-Open No. 2018-182051 for adjusting the sensitivity of a light receiving unit according to a count value of a counter of a plurality of bits cannot be applied.

### SUMMARY

The present disclosure is directed to provide a technique for maintaining ranging accuracy that could decrease as a result of the saturation of a signal value in a time gate type ranging device.

According to an embodiment of the present specification, there is provided a ranging device including a light receiving unit that outputs a micro-frame having a one-bit signal indicating presence or absence of incident light at a predetermined timing to a photoelectric conversion element, an addition unit that adds signal values of a plurality of the micro-frames output from the light receiving unit each for micro-frames that are based on the incident light at a same timing, and to generate a plurality of sub-frames each having a multi-bit signal acquired by adding signal values of two or more of the micro-frames, a determination unit that performs a determination to change or not change an operation condition of the light receiving unit or the addition unit based on signal values of the plurality of sub-frames, and a control unit configured to control the operation condition according to a determination result by the determination unit.

Further, according to another disclosure of the present specification, there is provided an information processing device including an input unit that receives a micro-frame having a one-bit signal indicating presence or absence of incident light on a light receiving unit at a predetermined timing, an addition unit that adds signal values of a plurality of the micro-frames input to the input unit each for micro-frames that are based on the incident light at a same predetermined timing, and to generate a plurality of sub-frames each having a multi-bit signal acquired by adding signal values of two or more of the micro-frames, a determination unit that performs a determination to change or not change an operation condition of the light receiving unit or the addition unit based on signal values of the plurality of sub-frames, and a control unit configured to control the operation condition according to a determination result by the determination unit.

Further, according to still another disclosure of the present specification, there is provided a ranging method including acquiring a micro-frame having a one-bit signal indicating presence or absence of incident light to a light receiving unit at a predetermined timing a plurality of times while changing the predetermined timing, adding acquired signal values of a plurality of the micro-frames each for micro-frames that are based on the incident light at a same timing, and generating a plurality of sub-frames each having a multi-bit signal acquired by adding signal values of two or more of the micro-frames, performing a determination to change or not change an operation condition of the light receiving unit or the addition unit based on the signal values of the plurality of sub-frames, and controlling the operation condition based on a result of the determination.

Features of the present disclosure will become apparent from the following description of embodiments with reference to the attached drawings. The following description of embodiments is described by way of example.

### BRIEF DESCRIPTION OF THE DRAWINGS

FIG. 1 is a block diagram illustrating a schematic configuration of a ranging system according to a first embodiment.

FIG. 2 is a block diagram of a light source device in a ranging device according to the first embodiment.

FIG. 3 is a schematic diagram of a photodetection device in the ranging device according to the first embodiment.

FIG. 4 is a plan view of an element substrate in the photodetection device according to the first embodiment.

FIG. 5 is a plan view of a circuit substrate in the photodetection device according to the first embodiment.

FIG. 6 is a block diagram of a pixel in the photodetection device according to the first embodiment.

FIGS. 7A, 7B, and 7C are diagrams illustrating a basic operation of the pixel in the photodetection device according to the first embodiment.

FIG. 8 is a diagram illustrating a configuration example of a ranging frame in the ranging device according to the first embodiment.

FIG. 9 is a diagram explaining a ranging method in the ranging device according to the first embodiment.

FIG. 10 is a diagram illustrating an example of a measurement result in the ranging device according to the first embodiment.

FIG. 11 is a flowchart illustrating a method of driving the ranging device according to the first embodiment.

FIG. 12 is a block diagram illustrating a configuration example of a determination unit in the ranging device according to the first embodiment.

FIG. 13 is a diagram illustrating an example of a method of calculating a maximum value and a minimum value of a sub-frame signal value.

FIG. 14 is a block diagram illustrating another configuration example of the determination unit in the ranging device according to the first embodiment.

FIG. 15 is a flowchart illustrating an operation example of the determination unit in the ranging device according to the first embodiment.

FIG. 16 is a diagram explaining a flow of a control operation based on a determination result of the determination unit.

FIGS. 17A and 17B are diagrams illustrating examples of changing the operation setting by the ranging device control unit.

FIGS. 18A and 18B are diagrams explaining the effect of the ranging device according to the first embodiment.

FIG. 19 is a block diagram illustrating a schematic configuration of a ranging system according to a second embodiment.

FIGS. 20A, 20B, and 20C are diagrams explaining a mode switching operation in the ranging system according to the second embodiment.

FIG. 21 is a block diagram illustrating a schematic configuration of a ranging system according to a third embodiment.

FIG. 22 is a block diagram illustrating a voltage control unit in the ranging device according to the third embodiment.

FIG. 23 is a block diagram of a pixel in a photodetection device according to a fourth embodiment.

FIG. 24 is a diagram illustrating a signal processing method in the ranging device according to the fourth embodiment.

FIGS. 25A and 25B are diagrams illustrating another arrangement example of the pixels in the photodetection device.

FIG. 26 is a flowchart illustrating a driving method in a case where a determination process is not performed.

FIGS. 27A and 27B are diagrams illustrating a configuration example of pixel blocks.

FIG. 28A is a diagram illustrating a configuration example of an equipment according to a fifth embodiment.

FIG. 28B is a diagram illustrating a configuration example of a movable object according to the fifth embodiment.

### DESCRIPTION OF THE EMBODIMENTS

Hereinafter, embodiments of the present disclosure will be described in detail with reference to the accompanying drawings. The following embodiments are intended to embody the technical idea of the present disclosure, and do not limit the present disclosure. Although multiple features are described in the embodiments, not all of these multiple features are essential to the present technology, and multiple features may be arbitrarily combined.

### First Embodiment

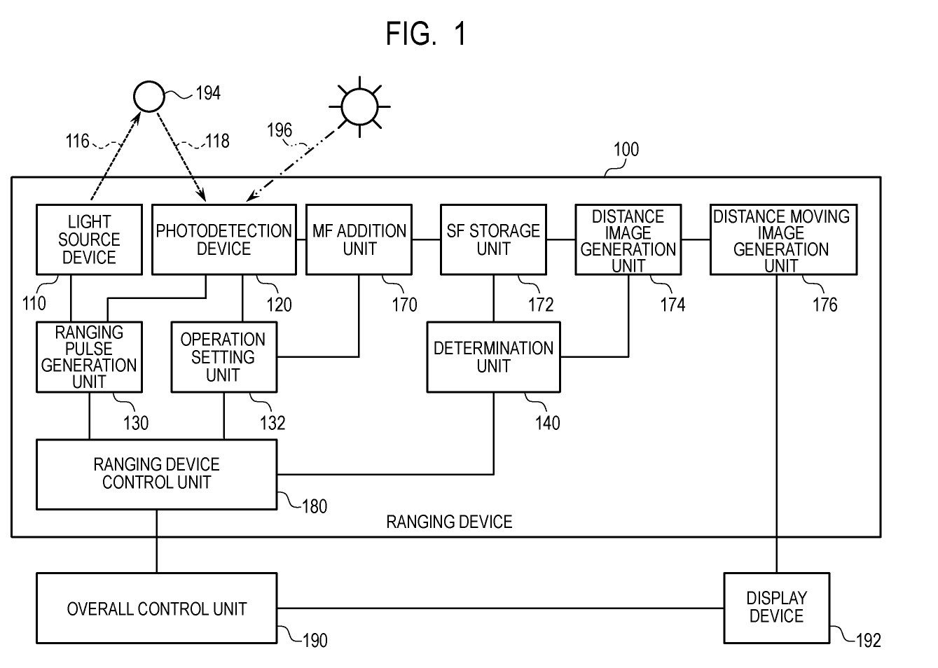

A schematic configuration of a ranging system according to a first embodiment will be described with reference to FIG. 1. FIG. 1 is a block diagram illustrating a schematic configuration of a ranging system according to the present embodiment.

As illustrated in FIG. 1, the ranging system according to the present embodiment may include a ranging device 100, an overall control device 190, and a display device 192. The ranging device 100 includes a light source device 110, a photodetection device 120, a ranging pulse generation unit 130, an operation setting unit 132, a determination unit 140, and a ranging device control unit 180. The ranging device 100 further includes a micro-frame addition unit (MF addition unit) 170, a sub-frame storage unit (SF storage unit) 172, a distance image generation unit 174, and a distance moving image generation unit 176.

The overall control device 190 is connected to the ranging device control unit 180 and the display device 192. The ranging device control unit 180 is connected to the ranging pulse generation unit 130, the operation setting unit 132, and the determination unit 140. The ranging pulse generation unit 130 is connected to the light source device 110 and the photodetection device 120. The photodetection device 120 is connected to the MF addition unit 170. The operation setting unit 132 is connected to the photodetection device 120 and the MF addition unit 170. The MF addition unit 170 is connected to the SF storage unit 172. The SF storage unit 172 is connected to the distance image generation unit 174. The determination unit 140 is connected to the SF storage unit 172 and the distance image generation unit 174. The distance image generation unit 174 is connected to the distance moving image generation unit 176. The distance moving image generation unit 176 is connected to the display device 192.

The overall control device 190 may include a printed circuit board on which an application specific integrated circuit (ASIC), a field programmable gate array (FPGA), and the like are mounted, software for controlling the ASIC and the FPGA, application software for simplifying a user operation, a plurality of interfaces connected to external devices, and the like. Here, the external device may include an input device such as a keyboard, a mouse, a touch panel, and a microphone, an output device such as an organic electroluminescent (EL) panel, a liquid crystal panel, a speaker, and headphones, and a function expansion device connected by a universal serial bus (USB), a peripheral component interconnect (PCI)-Express, a local area network (LAN), and the like. The overall control device 190 transmits to the ranging device 100 an instruction to generate distance image data in an operation mode set by a user operation, an instruction to transfer an image to the display device 192, and the like. In addition, the overall control device 190 transmits setting data such as the brightness, the resolution, and the refresh rate of the user setting to the display device 192.

The display device 192 receives the setting data of the overall control device 190 and displays the distance image data sent from the ranging device 100 on the monitor in a format based on the received setting.

The ranging device control unit 180 controls operation settings and driving timings of the light source device 110 and the photodetection device 120 based on an instruction received from the overall control device 190. More specifically, the ranging device control unit 180 controls the light emission timing of the irradiation pulsed light 116 from the light source device 110 and the light reception timing of the reflected pulsed light 118 from the object 194 by the photodetection device 120 via the ranging pulse generation unit 130. In addition, the ranging device control unit 180 performs operation setting of the photodetection device 120 and the MF addition unit 170 via the operation setting unit 132. The operation setting for the photodetection device 120 may include, for example, image display settings such as gain correction, black level correction, and white balance, and operation mode settings such as pixel addition/non-addition and region of interest (ROI). The operation setting for the MF addition unit 170 may include setting of the number of micro-frames to be added.

The micro-frame indicates one-bit image data. The photodetection device 120 serving as a light receiving unit receives the reflected pulsed light 118 from the object 194 at a predetermined timing and acquires a one-bit micro-frame. In general, the larger the number of micro-frames to be added, the better the S/N ratio. However, as the number of micro-frames to be added increases, the processing time required for the addition processing increases. Therefore, the MF addition unit 170 is set to have a good balance between the S/N ratio and the processing time.

In response to an instruction from the ranging device control unit 180, the ranging pulse generation unit 130 transmits a light source control pulse signal instructing light emission to the light source device 110 and transmits a gate signal which is a pulse signal instructing start/end of exposure to the photodetection device 120. In the ranging device 100 of the present embodiment, distance measurement at one point is performed using a time difference between a timing at which the light source control pulse signal changes and a timing at which the gate signal changes. In addition, distance information to the object 194 is obtained by performing distance measurement at a plurality of points while shifting the timing at which the gate signal changes. The drive timing of the light source control pulse signal and the gate signal will be described later in detail.

The operation setting unit 132 is a register unit that holds a setting value sent from the ranging device control unit 180 and includes a plurality of register groups that control the operation of the photodetection device 120.

The light source device 110 which is a light emitting unit includes a light source such as a vertical cavity surface emitting laser (VCSEL) and a peripheral circuit for driving the light source and emits short pulsed light in accordance with an instruction from the ranging pulse generation unit 130.

The photodetection device 120 includes a light receiving element such as a single photon avalanche diode (SPAD) and a peripheral circuit for driving the light receiving element and detects incident light at a level of one photon. The photodetection device 120 determines the exposure timing and the length of the exposure period according to the instruction from the ranging pulse generation unit 130.

The MF addition unit 170 may include an addition unit configured by an adder and a selection unit configured to select an output stage of the addition unit. The selection in the selection unit is based on the value set by the operation setting unit 132. For example, a case in which four times (four micro-frames) are set as the number of times of addition in the MF addition unit 170 capable of selecting the number of times of addition from 1 to N will be described as an example. In this case, the output of the third full adder from the preceding stage of the addition unit in which one half adder and the (N−1)-number of full adders are sequentially connected is selected as the output of the MF addition unit 170. The MF addition unit 170 calculates a sub-frame constituted by a multi-bit signal by adding the micro-frames acquired by the photodetection device 120 serving as the light receiving unit. The calculation of the sub-frame is repeated by the number of shifts of the gate signal.

The SF storage unit 172 holds the sub-frame output from the MF addition unit 170. Finally, the SF storage unit 172 holds a sub-frame group including sub-frames of the number corresponding to the number of shifts of the gate signal.

The distance image generation unit 174 generates a distance image based on a plurality of sub-frames acquired while shifting the gate signal, and on the saturation attribute received from the determination unit 140. The distance moving image generation unit 176 generates a distance moving image by compositing a plurality of distance images received from the distance image generation unit 174.

The determination unit 140 reads out the signal value of the sub-frame held in the SF storage unit 172 and determines whether or not it is necessary to change the operation condition when the next micro-frame is acquired.

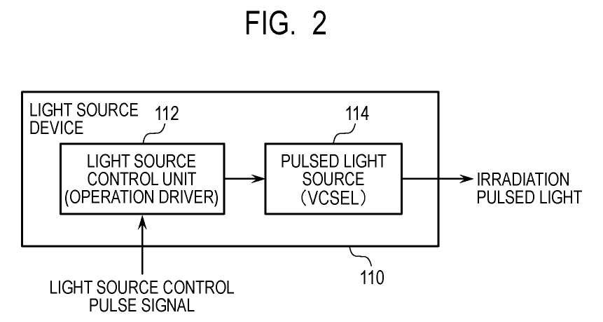

FIG. 2 is a block diagram illustrating a configuration example of the light source device 110. As illustrated in, e.g., FIG. 2, the light source device 110 may include a light source control unit 112 and a pulsed light source 114. The pulsed light source 114 is a light source that generates a pulsed laser and may be configured by a solid-state laser or a semiconductor laser. When miniaturization or power saving of the light source device 110 is required, application of a semiconductor laser may be used. As the semiconductor laser, an edge emitting laser (EEL) or a surface emitting laser (SEL) may be used. In particular, a vertical cavity surface emitting laser (VCSEL) may be used when two-dimensional array or high-speed modulation is required for the surface emitting laser. In the present embodiment, since modulation of a pulsed laser is required, a VCSEL that outputs a desired wavelength of 650 nm to 1080 nm is used as the pulsed light source 114. However, the emission wavelength band of the pulsed light source 114 is not limited thereto and may be, for example, a wavelength of 1310 nm or 1550 nm used for medium-to-long distance communication.

The light source control unit 112 is an operation driver that controls light emission of the pulsed laser (irradiation pulsed light 116) by the pulsed light source 114. The light source control unit 112 generates a light emission control signal which is a pulsed laser driving signal in accordance with the light source control pulse signal from the ranging pulse generation unit 130, and outputs the generated light emission control signal to the pulsed light source 114.

The pulsed light source 114 controls the irradiation pulsed light 116 in accordance with a light emission control signal from the light source control unit 112. For example, the pulsed light source 114 emits the laser pulsed light once or a plurality of times in response to an input of a light emission control signal from the light source control unit 112. In the present embodiment, it is assumed that the laser pulsed light is emitted once in response to one light emission control signal input from the light source control unit 112.

The pulsed light source 114 irradiates an object 194 with irradiation pulsed light 116 which is a pulsed laser. When the object 194 is irradiated with the irradiation pulsed light 116, a part of the irradiation pulsed light 116 is reflected by the object 194 and enters the photodetection device 120 as the reflected pulsed light 118. The reflected pulsed light 118 is a part of the irradiation pulsed light 116. In addition to the reflected pulsed light 118 from the object 194, the light incident on the photodetection device 120 includes environmental light (external light such as sunlight or illumination) 196 in the measurement target region (see FIG. 1).

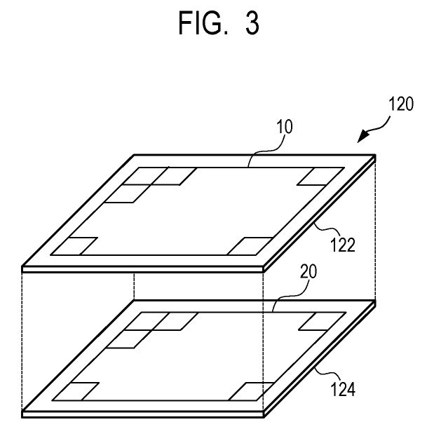

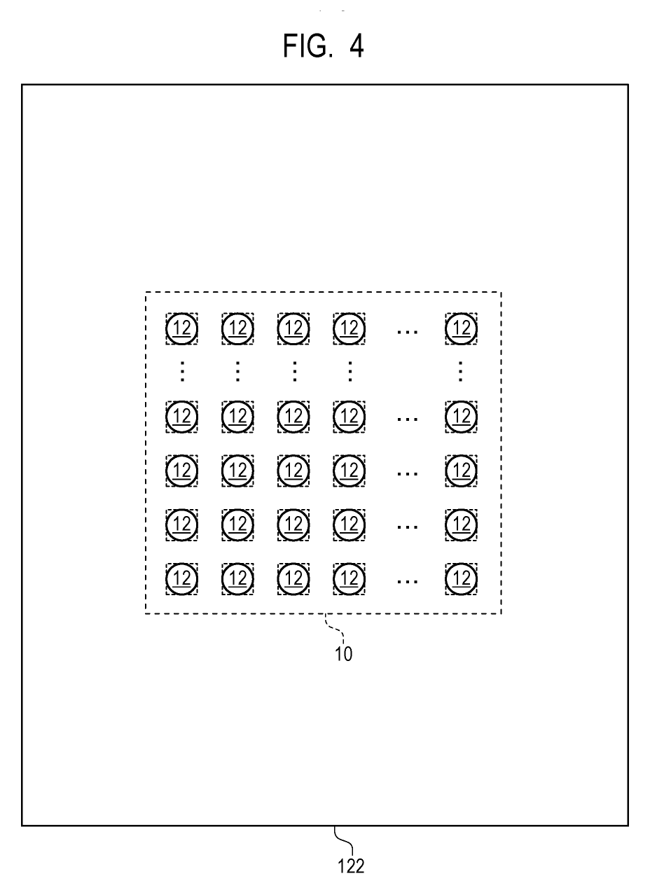

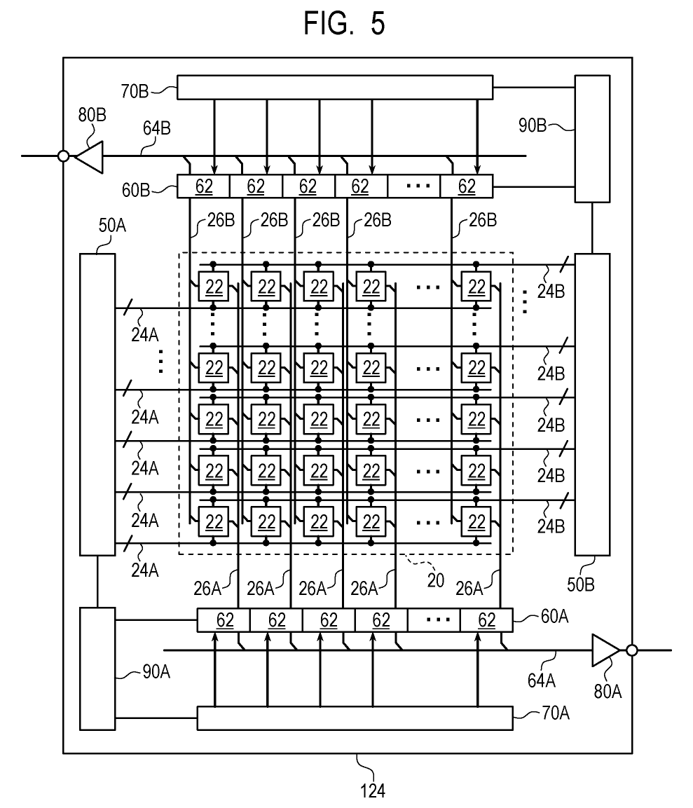

Next, a configuration example of the photodetection device 120 in the ranging device 100 according to the present embodiment will be described with reference to FIGS. 3-5. FIG. 3 is a schematic diagram illustrating a configuration example of the photodetection device 120 in the ranging device 100 according to the present embodiment. FIG. 4 is a plan view illustrating the element substrate 122 constituting the photodetection device 120. FIG. 5 is a plan view illustrating the circuit substrate 124 constituting the photodetection device 120.

The photodetection device 120 is not particularly limited but may be configured by a stacked-type photoelectric conversion device in which an element substrate 122 and a circuit substrate 124 are stacked as illustrated in FIG. 3, for example. The element substrate 122 and the circuit substrate 124 are electrically connected to each other via a plurality of interconnections. By configuring the stacked-type photodetection device 120, it is possible to increase the degree of integration of elements and achieve higher functionality.

As illustrated in FIG. 4, the pixel region 10 is provided in the element substrate 122. The pixel region 10 is provided with a plurality of photoelectric conversion units 12 arranged in a matrix so as to form a plurality of rows and a plurality of columns. The photoelectric conversion unit 12 may include a photoelectric conversion element such as a photodiode.

As illustrated in FIG. 5, the circuit substrate 124 is provided with a pixel circuit region 20, vertical scanning circuits 50A and 50B, readout circuits 60A and 60B, horizontal scanning circuits 70A and 70B, output circuits 80A and 80B, and control signal generation units 90A and 90B.

The pixel circuit region 20 is provided with a plurality of pixel signal processing units 22 arranged in a matrix so as to form a plurality of rows and a plurality of columns. The plurality of pixel signal processing units 22 are provided corresponding to the plurality of photoelectric conversion units 12 provided on the element substrate 122, and each of the sets of the photoelectric conversion units 12 and the pixel signal processing unit 22 configures one pixel 30. The photoelectric conversion unit 12 of the element substrate 122 constituting each pixel 30 and the pixel signal processing unit 22 of the circuit substrate 124 are electrically connected to each other via interconnections provided respectively. By arranging the photoelectric conversion unit 12 and the pixel signal processing unit 22 on different substrates, the photoelectric conversion elements may be arranged at high density without sacrificing the light receiving area of the photoelectric conversion elements constituting the photoelectric conversion unit 12, and the photon detection efficiency may be improved. A specific configuration example of the pixel 30 will be described later.

The arrangement of the photoelectric conversion units 12 in the pixel region 10 is not necessarily two-dimensional and may be one-dimensional. In addition, one pixel signal processing unit 22 may not necessarily be provided for every pixel 30. For example, one pixel signal processing unit 22 may be shared by a plurality of photoelectric conversion units 12. In this case, the pixel signal processing unit 22 may provide a signal processing function to each photoelectric conversion unit 12 by sequentially processing signals output from the corresponding photoelectric conversion units 12.

In each row of the pixel circuit region 20, control lines 24A and 24B are arranged so as to extend in a first direction (lateral direction in FIG. 5). Each of the control lines 24A and 24B is connected to the pixel signal processing units 22 arranged in the first direction in the corresponding row and forms a signal line common to these pixel signal processing units 22. Each of the control lines 24A, 24B may include a plurality of signal lines. The first direction in which the control lines 24A and 24B extend may be referred to as a row direction or a horizontal direction. The control lines 24A are connected to the vertical scanning circuit 50A. The control lines 24B are connected to the vertical scanning circuit 50B.

In each column of the pixel circuit region 20, output lines 26A and 26B are arranged so as to extend in a second direction (vertical direction in FIG. 5) intersecting the first direction. Each of the output lines 26A and 26B is connected to the pixel signal processing units 22 arranged in the second direction in the corresponding column and forms a signal line common to these pixel signal processing units 22. Each of the output lines 26A, 26B may include a plurality of signal lines. The second direction in which the output lines 26A and 26B extend may be referred to as a column direction or a vertical direction. The output lines 26A are connected to the readout circuit 60A. The output lines 26B are connected to the readout circuit 60B. The output line 26A has a function of outputting the digital signal generated in the pixel signal processing unit 22 of the corresponding column to the readout circuit 60A, and a function of supplying a control signal for selecting a column to which a signal is to be output to the pixel signal processing unit 22 of the corresponding column. Similarly, the output line 26B has a function of outputting the digital signal generated in the pixel signal processing unit 22 of the corresponding column to the readout circuit 60B, and a function of supplying a control signal for selecting a column to which a signal is to be output to the pixel signal processing unit 22 of the corresponding column.

The vertical scanning circuit 50A has a function of generating a control signal for driving the pixels 30 in accordance with a control signal from the control signal generation unit 90A and outputting the generated control signal to the pixel circuit region 20. The vertical scanning circuit 50A sequentially outputs the control signals to the control lines 24A of each row and performs an operation of sequentially driving the pixels 30 of the pixel circuit region 20 in units of rows, that is, so-called vertical scanning. The signals read out from the pixels 30 in units of rows are input to the readout circuit 60A via the output lines 26A arranged in the respective columns of the pixel circuit region 20. Similarly, the vertical scanning circuit 50B has a function of generating a control signal for driving the pixels 30 in accordance with a control signal from the control signal generation unit 90B and outputting the generated control signal to the pixel circuit region 20. The vertical scanning circuit 50B sequentially outputs the control signals to the control lines 24B of each row and performs an operation of sequentially driving the pixels 30 of the pixel circuit region 20 in units of rows, that is, so-called vertical scanning. The signals read out from the pixels 30 in units of rows are input to the readout circuit 60B via the output lines 26B arranged in the respective columns of the pixel circuit region 20. A logic circuit such as a shift register or an address decoder may be used for the vertical scanning circuits 50A and 50B.

The readout circuit 60A includes a plurality of column circuits 62 corresponding to the number of columns in which the output lines 26A are arranged. Each of the column circuits 62 of the readout circuit 60A is connected to the output line 26A of the corresponding column. Similarly, the readout circuit 60B includes a plurality of column circuits 62 corresponding to the number of columns in which the output lines 26B are arranged. Each of the column circuits 62 of the readout circuit 60B is connected to the output line 26B of the corresponding column. Each of the column circuits 62 includes a holding unit (not illustrated) and has a function of holding the pixel signal of the pixel 30 of the corresponding column output from the pixel circuit region 20 in units of rows via the output line 26A or 26B.

The horizontal scanning circuit 70A has a function of generating a control signal for reading out the pixel signal from the column circuit 62 of the readout circuit 60A in accordance with a control signal from the control signal generation unit 90A and outputting the generated control signal to the readout circuit 60A. The horizontal scanning circuit 70A performs an operation of sequentially scanning the column circuits 62 of the readout circuit 60A to thereby sequentially output the pixel signals held therein to the output circuit 80A via the horizontal output line 64A, that is, a so-called horizontal scanning. Similarly, the horizontal scanning circuit 70B has a function of generating a control signal for reading out the pixel signal from the column circuit 62 of the readout circuit 60B in accordance with a control signal from the control signal generation unit 90B and outputting the generated control signal to the readout circuit 60B. The horizontal scanning circuit 70B performs the same horizontal scanning as that of the horizontal scanning circuit 70A on the column circuits 62 of the readout circuit 60B to thereby sequentially output the pixel signals held therein to the output circuit 80B via the horizontal output line 64B. A logic circuit such as a shift register or an address decoder may be used for the horizontal scanning circuits 70A and 70B.

The output circuit 80A is a circuit unit for outputting the pixel signal output from the readout circuit 60A to the outside of the photodetection device 120 and includes an external interface circuit. Similarly, the output circuit 80B is a circuit unit for outputting the pixel signal output from the readout circuit 60B to the outside of the photodetection device 120 and includes an external interface circuit. The external interface circuits included in the output circuits 80A and 80B are not particularly limited. As the external interface circuit, for example, a serializer/deserializer (SerDes) transmission circuit may be applied. Examples of the SerDes transmission circuit include a low voltage differential signaling (LVDS) circuit and a scalable low voltage signaling (SLVS) circuit.

The control signal generation unit 90A is a control circuit for generating control signals for controlling operations and timings thereof of the vertical scanning circuit 50A, the readout circuit 60A, and the horizontal scanning circuit 70A and supplying the control signal to each functional block. Similarly, the control signal generation unit 90B is a control circuit for generating control signals for controlling operations and timings thereof of the vertical scanning circuit 50B, the readout circuit 60B, and the horizontal scanning circuit 70B and supplying the control signal to each functional block. At least a part of the control signals for controlling the operations and timings of the vertical scanning circuits 50A and 50B, the readout circuits 60A and 60B, and the horizontal scanning circuits 70A and 70B may be supplied from the outside of the photodetection device 120.

The element substrate 122 and the circuit substrate 124 are bonded so that the pixel region 10 and the pixel circuit region 20 overlap each other in a plan view. The other functional blocks excluding the pixel region 10 and the pixel circuit region 20 may be arranged on the circuit substrate 124 so as to overlap the region between the end of the element substrate 122 and the end of the pixel region 10 in the plan view.

The arrangement of the output lines 26A and 26B, the arrangement of the readout circuits 60A and 60B, and the arrangement of the output circuits 80A and 80B are not limited to the example of FIG. 5. For example, the output lines 26A and 26B may be arranged so as to extend in the row direction, and each may be connected to the pixel signal processing unit 22 in the corresponding row. In this case, the readout circuits 60A and 60B may be arranged so that the output lines 26A and 26B of each row are connected.

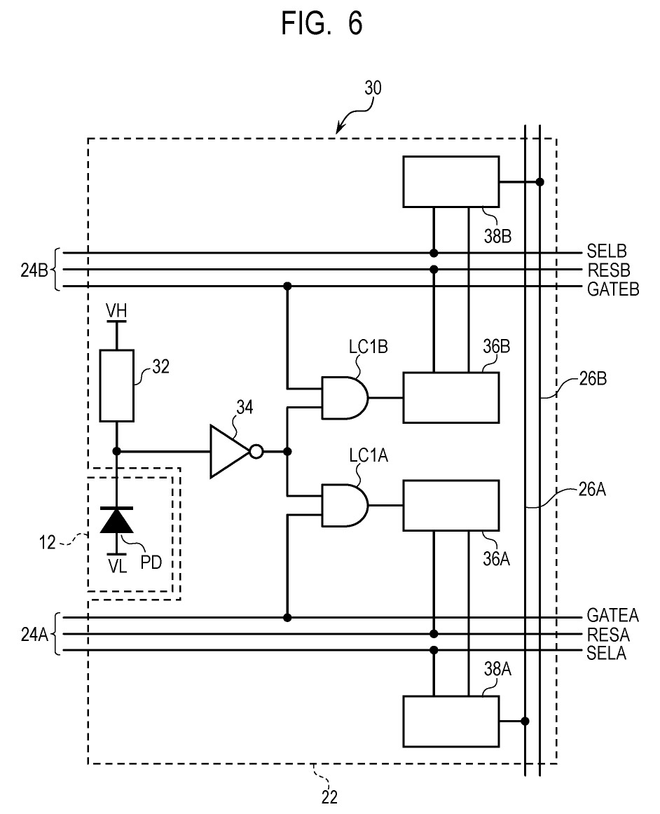

Next, a configuration example of the pixel 30 in the photodetection device 120 according to the present embodiment will be described with reference to FIG. 6. FIG. 6 is a block diagram illustrating a configuration example of the pixel 30 in the photodetection device 120 according to the present embodiment.

As illustrated in FIG. 6, the pixel 30 of the photodetection device 120 according to the present embodiment may include the photoelectric conversion unit 12 and the pixel signal processing unit 22. The photoelectric conversion unit 12 includes a photoelectric conversion element PD. The pixel signal processing unit 22 includes a quenching element 32, a waveform shaping unit 34, micro-frame holding units (MF holding units) 36A and 36B, selection circuits 38A and 38B, and gating circuits LC1A and LC1B. In the case of the circuit configuration of FIG. 6, the control line 24A may include three signal lines supplying control signals GATEA, RESA, and SELA from the vertical scanning circuit 50A, and the control line 24B may include three signal lines supplying control signals GATEB, RESB, and SELB from the vertical scanning circuit 50B. The control signals GATEA, GATEB, RESA, RESB, SELA, and SELB will be described later.

The photoelectric conversion element PD may be an avalanche photodiode (hereinafter referred to as "APD"). An anode of the APD constituting the photoelectric conversion element PD is connected to a node to which a voltage VL is supplied. A cathode of the APD constituting the photoelectric conversion element PD is connected to one terminal of the quenching element 32. A connection node between the photoelectric conversion element PD and the quenching element 32 is an output node of the photoelectric conversion unit 12. The other terminal of the quenching element 32 is connected to a node to which a voltage VH higher than the voltage VL is supplied. The voltage VL and the voltage VH are set so that a reverse bias voltage sufficient for the APD to perform the avalanche multiplication operation is applied. In one example, a negative high voltage is applied as the voltage VL, and a positive voltage comparable to the power supply voltage is applied as the voltage VH. For example, the voltage VL is −30 V, and the voltage VH is +1 V.

The photoelectric conversion element PD may be the APD as described above. When a reverse bias voltage sufficient to perform the avalanche multiplication operation is supplied to the APD, carriers generated by light incidence cause avalanche multiplication, and an avalanche current is generated. The operation modes in a state where the reverse bias voltage is supplied to the APD include a Geiger mode and a linear mode. The Geiger mode is an operation mode in which a voltage applied between the anode and the cathode is set to a reverse bias voltage larger than the breakdown voltage of the APD. The linear mode is an operation mode in which a voltage applied between the anode and the cathode is set to a reverse bias voltage close to or lower than the breakdown voltage of the APD. An APD that operates in Geiger mode is referred to as a single photon avalanche diode (SPAD). The APD constituting the photoelectric conversion element PD may be operated in the linear mode or in the Geiger mode, but the SPAD in which the potential difference is large and the effect of improving the signal-to-noise ratio is remarkable is more preferable than the APD in the linear mode.

The quenching element 32 has a function of converting a change in the avalanche current generated in the APD into a voltage signal. In addition, the quenching element 32 functions as a load circuit (quenching circuit) at the time of signal multiplication by avalanche multiplication and has a function of suppressing avalanche multiplication by reducing a voltage applied to the APD. The operation in which the quenching element 32 suppresses avalanche multiplication is called a quenching operation. The quenching element 32 has a function of returning the voltage supplied to the APD to the voltage VH by flowing a current corresponding to the voltage drop due to the quenching operation. The operation of returning the voltage supplied from the quenching element 32 to the APD to the voltage VH is called a recharge operation. The quenching element 32 may be configured by a resistor, a MOS transistor, or the like.

The waveform shaping unit 34 includes an input node to which the output signal of the photoelectric conversion unit 12 is input and an output node. The waveform shaping unit 34 has a function of converting an analog signal output from the photoelectric conversion unit 12 into a pulse signal. The waveform shaping unit 34 may be constituted by a logic circuit including, for example, a NOT circuit (inverter circuit), a NOR circuit, a NAND circuit, or the like. Although FIG. 6 illustrates an example in which one inverter circuit is used as the waveform shaping unit 34, a circuit in which a plurality of inverter circuits is connected in series may be used, or another circuit having a waveform shaping effect may be used.

The gating circuits LC1A and LC1B perform gating to pass the pulse signal output from the waveform shaping unit 34 for a predetermined period. Here, the predetermined period is a period in which signal generation based on incident light is performed in the pixel 30. The gating circuits LC1A and LC1B may be constituted by, e.g., a two-input AND circuit as illustrated in FIG. 6. One input node of each of the AND circuits constituting the gating circuits LC1A and LC1B is connected to the output node of the waveform shaping unit 34. The control signal GATEA from the control line 24A is input to the other input node of the AND circuit constituting the gating circuit LC1A. The control signal GATEB from the control line 24B is input to the other input node of the AND circuit constituting the gating circuit LC1B. An output node of the gating circuit LC1A is connected to the MF holding unit 36A. An output node of the gating circuit LC1B is connected to the MF holding unit 36B. That is, the pulse signal output from the waveform shaping unit 34 is output to the MF holding unit 36A while the control signal GATEA is at high-level and is output to the MF holding unit 36B while the control signal GATEB is at high-level. Note that the gating circuits LC1A and LC1B are not particularly limited as long as they can realize predetermined gating and may have a circuit configuration other than the AND circuit.

The MF holding unit 36A has a function of holding the number of pulse signals output from the waveform shaping unit 34 via the gating circuit LC1A. The MF holding unit 36A is supplied with the control signal RESA from the control line 24A. The number of pulse signals held in the MF holding unit 36A is reset to an initial value (zero) when a high-level control signal RESA is received. Similarly, the MF holding unit 36B has a function of holding the number of pulse signals output from the waveform shaping unit 34 via the gating circuit LC1B. The MF holding unit 36B is supplied with the control signal RESB from the control line 24B. The number of pulse signals held in the MF holding unit 36B is reset to an initial value (zero) when a high-level control signal RESB is received.

The selection circuit 38A has a function of switching an electrical connection state (connection or non-connection) between the MF holding unit 36A and the output line 26A. The selection circuit 38A switches the connection state between the MF holding unit 36A and the output line 26A according to the control signal SELA supplied from the vertical scanning circuit 50A via the control line 24A. Similarly, the selection circuit 38B has a function of switching an electrical connection state (connection or non-connection) between the MF holding unit 36B and the output line 26B. The selection circuit 38B switches the connection state between the MF holding unit 36B and the output line 26B according to the control signal SELB supplied from the vertical scanning circuit 50B via the control line 24B. The selection circuits 38A and 38B may further include a buffer circuit for outputting a signal.

In the configuration example of FIG. 6, electrical connection/disconnection between the MF holding unit 36A and the output line 26A is switched by the selection circuit 38A, and electrical connection/disconnection between the MF holding unit 36B and the output line 26B is switched by the selection circuit 38B. However, the method of controlling the signal output to the output lines 26A and 26B is not limited to this method. For example, a switch such as a transistor may be provided at a node between the photoelectric conversion element PD and the quenching element 32 or between the photoelectric conversion unit 12 and the pixel signal processing unit 22, and the signal output to the output lines 26A and 26B may be controlled by switching between electrical connection and non-connection of the switch. Alternatively, the signal output to the output lines 26A and 26B may be controlled by switching the values of the voltages VH and VL supplied to the photoelectric conversion unit 12 using a switch such as a transistor.

As illustrated in FIG. 6, the pixel 30 according to the present embodiment includes two sets of a gating circuit LC1, an MF holding unit 36, and a selection circuit 38 for one set of the photoelectric conversion element PD, the quenching element 32, and the waveform shaping unit 34. By configuring the pixel 30 in this manner, it is possible to acquire two kinds of signals having different exposure periods based on the output signal from one photoelectric conversion element PD. However, the pixel 30 does not necessarily output two types of signals and may output one type of signal having the same exposure period.

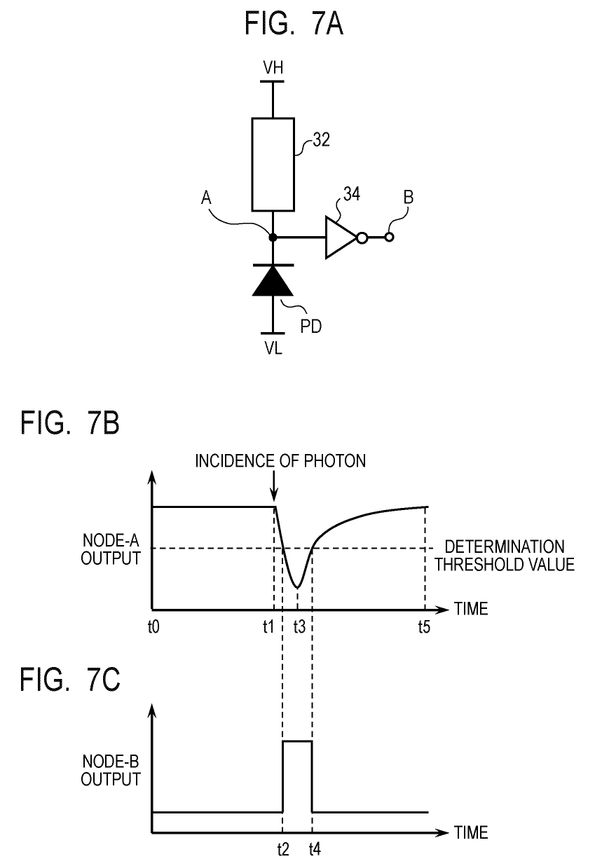

Next, basic operations of the photoelectric conversion element PD, the quenching element 32, and the waveform shaping unit 34 in the pixel 30 of the photodetection device 120 according to the present embodiment will be described with reference to FIGS. 7A-7C. FIGS. 7A-7C are diagrams illustrating a basic operation of pixel in the photoelectric conversion device according to the present embodiment. FIG. 7A is a circuit diagram illustrating the portion of the photoelectric conversion element PD, the quenching element 32, and the waveform shaping unit 34 of the pixel 30. FIG. 7B illustrates a waveform of a signal at an output node (node-A) of the photoelectric conversion unit 12, and FIG. 7C illustrates a waveform of a signal at an output node (node-B) of the waveform shaping unit 34. Here, in order to simplify the description, it is assumed that the waveform shaping unit 34 is constituted by an inverter circuit.

At time t0, a reverse bias voltage having a potential difference corresponding to (VH−VL) is applied to the photoelectric conversion element PD. Although a reverse bias voltage sufficient to cause avalanche multiplication is applied between the anode and the cathode of the photoelectric conversion element PD, carriers serving as seeds of avalanche multiplication do not exist in a state where photons are not incident on the photoelectric conversion element PD. Therefore, avalanche multiplication does not occur in the photoelectric conversion element PD, and no current flows through the photoelectric conversion element PD.

At the subsequent time t1, it is assumed that a photon is incident on the photoelectric conversion element PD. When a photon enters the photoelectric conversion element PD, an electron-hole pair is generated by photoelectric conversion, avalanche multiplication occurs using these carriers as seeds, and an avalanche current flows through the photoelectric conversion element PD. When this avalanche current flows through the quenching element 32, a voltage drop occurs due to the quenching element 32, and the voltage of the node-A starts to drop. When the voltage drop amount of the node-A becomes large and the avalanche multiplication is stopped at time t3, the voltage level of the node-A no longer drops.

When the avalanche multiplication in the photoelectric conversion element PD is stopped, a current that compensates for the voltage drop flows from the node to which the voltage VL is supplied to the node-A through the photoelectric conversion element PD, and the voltage of the node-A gradually increases. Thereafter, at time t5, the node-A is settled to the original voltage level.

The waveform shaping unit binarizes the signal input from the node-A according to a predetermined determination threshold value and outputs the binarized signal from the node-B. Specifically, the waveform shaping unit 34 outputs a low-level signal from the node-B when the voltage level of the node-A exceeds the determination threshold value, and outputs a high-level signal from the node-B when the voltage level of the node-A is equal to or lower than the determination threshold value. For example, as illustrated in FIG. 7B, it is assumed that the voltage of the node-A is equal to or lower than the determination threshold value in the period from the time t2 to the time t4. In this case, as illustrated in FIG. 7C, the signal level at the node-B becomes low-level in the period from the time t0 to the time t2 and the period from the time t4 to the time t5 and becomes high-level in the period from the time t2 to the time t4.

In this way, the analog signal input from the node-A is waveform-shaped into a digital signal by the waveform shaping unit 34. A pulse signal output from the waveform shaping unit 34 in response to incidence of a photon on the photoelectric conversion element PD is a photon detection pulse signal. Note that the waveform shaping unit 34 may also be referred to as an avalanche multiplication detection circuit that detects an avalanche multiplication operation in the photoelectric conversion element PD and outputs a pulse signal.

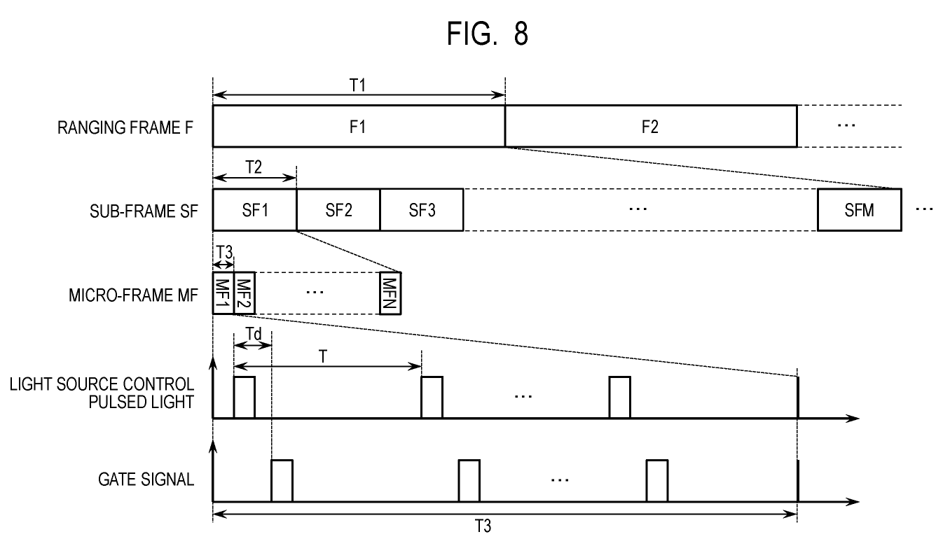

Next, the configurations of a ranging frame, a sub-frame, and a micro-frame used to generate a distance image in the ranging device 100 according to the present embodiment will be described with reference to FIG. 8. In the upper part of FIG. 8, acquisition periods of a ranging frame F corresponding to a distance image, a sub-frame SF used to generate the ranging frame, and a micro-frame MF used to generate the sub-frame SF are schematically illustrated by arranging blocks in the horizontal direction. The horizontal direction in FIG. 8 indicates the passage of time, and one block indicates the acquisition period of one ranging frame F, sub-frame SF, or micro-frame MF.

The ranging frame F corresponds to one distance image. That is, the ranging frame F has information corresponding to the distance to the object 194 calculated from the time difference from when light is emitted to when light is received for each of the plurality of pixels 30 included in the photodetection device 120. In the present embodiment, it is assumed that a distance image is acquired as a moving image, and acquisition of one ranging frame F is repeatedly performed every time one ranging frame period T1 elapses. FIG. 8 illustrates a first ranging frame F1 and a second ranging frame F2 following the first ranging frame F1, among a plurality of consecutive ranging frames F.

One ranging frame F is generated from a plurality of sub-frames SF. One ranging frame period T1 includes a plurality of sub-frame periods T2. One sub-frame SF is acquired for each sub-frame period T2. The sub-frame SF is constituted by a multi-bit signal corresponding to the amount of light detected during the sub-frame period T2. FIG. 8 illustrates M-number of sub-frames SF1, SF2, ... , and SFM constituting the ranging frame F. The number of sub-frames SF constituting one ranging frame F is not particularly limited.

One sub-frame SF is generated from a plurality of micro-frames MF. One sub-frame period T2 includes a plurality of micro-frame periods T3. One micro-frame MF is acquired for each micro-frame period T3. The micro-frame MF is constituted by a one-bit signal indicating the presence or absence of incident light on the photoelectric conversion element PD in the micro-frame period T3. One sub-frame SF of the multi-bit signal is generated by adding and compositing a plurality of micro-frames MF of the one-bit signal. Accordingly, one sub-frame SF may include a multi-bit signal corresponding to the number of micro-frames MF in which incident light is detected in the sub-frame period T2. FIG. 8 illustrates N-number of micro-frames MF1, MF2, ... , and MFN constituting the sub-frame SF. The number of the micro-frames MF constituting one sub-frame SF is not particularly limited.

In the lower part of FIG. 8, the operation of the ranging device 100 in the micro-frame MF is schematically illustrated. The ranging device control unit 180 instructs the ranging pulse generation unit 130 to generate the light source control pulse signal and the gate signal. The ranging pulse generation unit 130 generates the light source control pulse signal and the gate signal in response to an instruction from the ranging device control unit 180. The light source control pulse signal is a control signal output from the ranging pulse generation unit 130 to the light source device 110 and indicates that the light source device 110 is emitting light during a high-level period. The gate signal is a control signal output from the ranging pulse generation unit 130 to each pixel 30 of the photodetection device 120 and indicates that light can be detected by the pixel 30 during a high-level period.

The light source control pulse signal is controlled to be at high-level periodically at a constant cycle T during the micro-frame period T3. The light source device 110 is in a state of outputting the irradiation pulsed light 116 during a period of receiving the high-level light source control pulse signal and is in a state of not outputting the irradiation pulsed light 116 during a period of receiving the low-level light source control pulse signal. The relationship between the signal level of the light source control pulse signal and the on/off operation of the light source device 110 may be arbitrarily set.

The gate signals (control signals GATEA and GATEB) are controlled so as to be at high-level with a delay of a predetermined time (delay time: td) in the period T with respect to each period in which the light source control pulse signal is at high-level. The period in which the gate signal is at high-level corresponds to a period in which the photodetection device 120 is controlled to a state in which light can be detected, and the period in which the gate signal is at low-level corresponds to a period in which the photodetection device 120 is controlled to a stop state in which light is not detected. Although the gate signal is generated in the ranging pulse generation unit 130, the gate signal is generated at a timing synchronized with the light source control pulse signal so as to have a predetermined delay time with respect to the light source control pulse signal under the control of the ranging device control unit 180. The delay time of the gate signal with respect to the light source control pulse signal is set to a different time for each sub-frame SF. The relationship between the signal level of the gate signal and the operation of the photodetection device 120 may be arbitrarily set.

Each of the pixels 30 included in the photodetection device 120 is in a state (on state) in which light can be detected while the gate signal is at high-level and is in a stop state (off state) in which light is not detected while the gate signal is at low-level. Each pixel 30 is configured to output a one-bit signal indicating data held by the MF holding units 36A and 36B to the MF addition unit 170 after the micro-frame period T3 elapses.

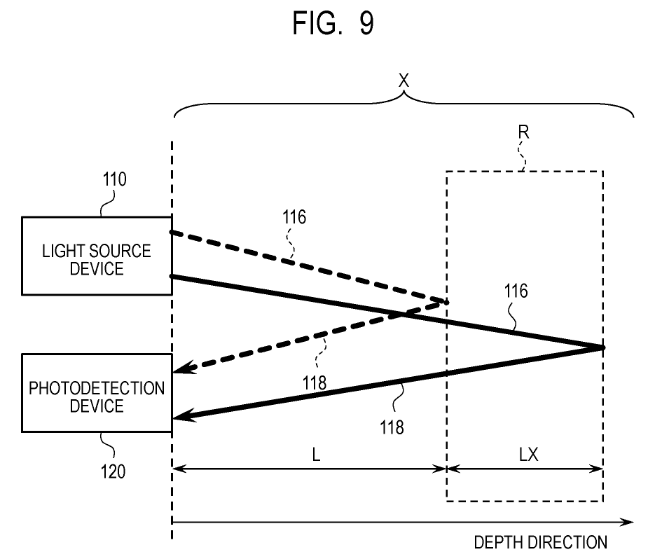

The relationship between the light source control pulse signal and the gate signal will be described in more detail with reference to FIG. 9. Here, as illustrated in FIG. 9, it is assumed that a region R in which the distance from each of the light source device 110 and the photodetection device 120 is L and the thickness in the depth direction is LX exists in the measurement target region X which is an irradiation region of the light (irradiation pulsed light 116) emitted from the light source device 110. In this case, the optical path length of the light emitted from the light source device 110, reflected at the position of the surface on the side of the light source device 110 and the photodetection device 120 in the region R, and reaching the photodetection device 120 is 2L. On the other hand, the optical path length of the light emitted from the light source device 110, reflected at the position of the surface opposite to the light source device 110 and the photodetection device 120 in the region R, and reaching the photodetection device 120 is 2(L+LX). Due to this difference in optical path length, a time difference occurs between the timing at which the light reflected at the position on the side of the light source device 110 and the photodetection device 120 in the region R is detected and the timing at which the light reflected at the position on the opposite side of the light source device 110 and the photodetection device 120 in the region R is detected. This time difference may be expressed as 2LX/c, where c is the speed of light.

By setting the photodetection device 120 to the detection period only during the period corresponding to the time difference, it is possible to selectively acquire information of the measurement target located in the region R in the measurement target region X. That is, in FIG. 8, the time from the timing when the light source control pulse signal becomes high-level to the timing when the gate signal becomes high-level is set to the time corresponding to the distance of 2L, and the time width of the gate signal is set to the time corresponding to the distance of 2LX. By setting the detection period of the photodetection device 120 in this manner, it is possible to acquire the micro-frame MF including the information of the measurement target located in the region R.

It is assumed here that the range from the distance L to the thickness LX set in the detection period of the photodetection device 120 is referred to as a measurement target distance range, the sub-frames SF1, SF2, SF3, ... , and SFM constituting the ranging frames F1, F2, ... have different measurement target distance ranges. The measurement target distance ranges in the plurality of micro-frames MF1, MF2, MF3, ... , and MFN constituting one sub-frame SF are the same. In addition, it is also assumed here that a period in which the gate signal becomes high-level corresponding to the measurement target distance range is referred to as a gating period, the gating periods of the sub-frames SF1, SF2, SF3, ... , and SFM constituting the ranging frames F1, F2, ... are different from each other. The plurality of micro-frames MF1, MF2, MF3, ... , and MFN constituting one sub-frame SF have the same gating period.

In the present embodiment, a plurality of sub-frames SF is acquired while sequentially shifting the measurement target distance range (gating period). That is, the pulsed light corresponding to each of the plurality of measurement target distance ranges constituting the measurement target region X is detected in a time division manner by sequentially switching the detection periods during which the photodetection device 120 may detect the pulsed light. With this configuration, it is possible to obtain the distribution of the signal values of the sub-frame SF with respect to the distance to be measured. Since the measured distance range in which the signal value is the maximum is estimated as a region in which the object 194 reflecting the irradiation pulsed light 116 exists, the distance to the object 194 may be calculated from the information of the measured distance range in which the signal value is the maximum. In addition, a distance image (also referred to as a ranging frame) may be generated by calculating a distance for each pixel 30 and acquiring a two-dimensional distribution of distances.

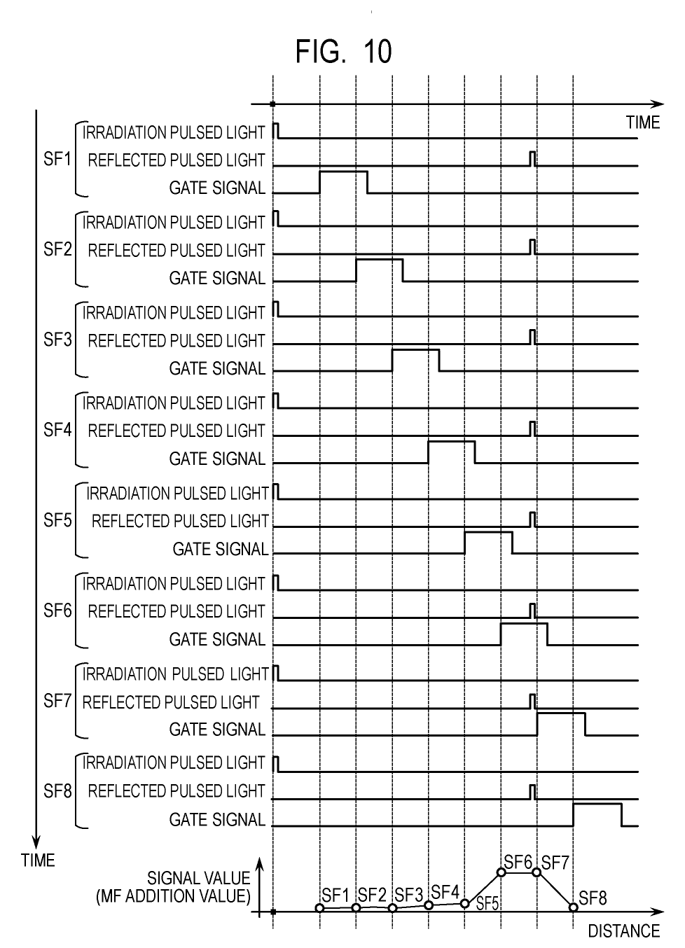

FIG. 10 is a diagram illustrating an example of the waveforms of the irradiation pulsed light 116, the reflected pulsed light 118, and the gate signal in the sub-frames SF and the distribution of the signal values in the sub-frames SF. The upper part illustrates waveforms of the irradiation pulsed light 116, the reflected pulsed light 118, and the gate signal in each of the sub-frames SF1 to SF8 acquired for a certain object. The distribution of the signal values in the sub-frames SF1 to SF8 is illustrated in the lower part. The signal values of the sub-frames SF are added values of the corresponding micro-frames MF. As illustrated in FIG. 10, when the timing at which the pulse of the gate signal becomes active and the timing at which the reflected pulsed light 118 enters coincide with each other, the signal value of the sub-frame SF becomes high.

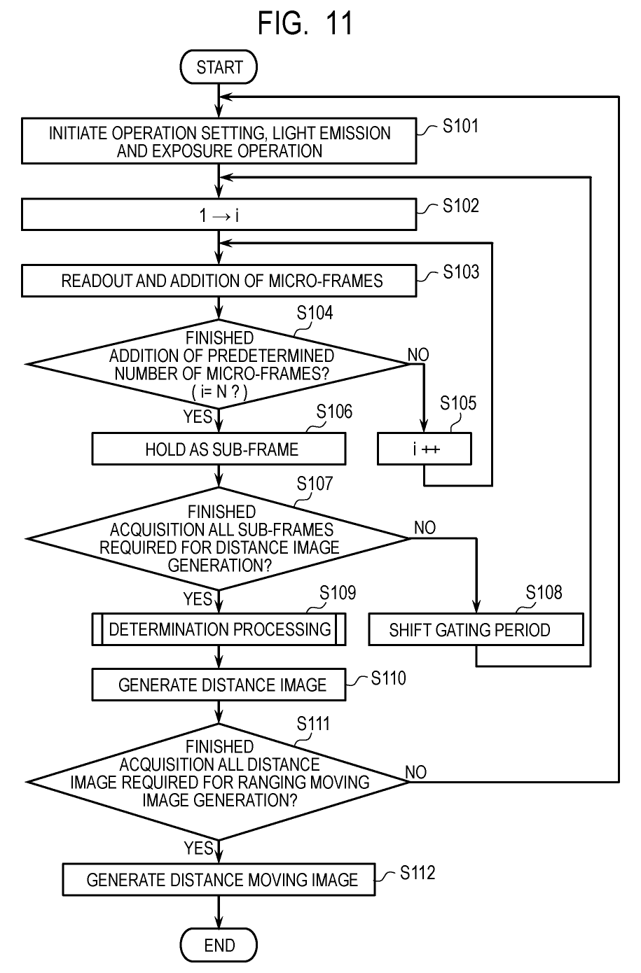

Next, a method of driving the ranging device according to the present embodiment will be described with reference to FIG. 11. FIG. 11 is a flowchart illustrating an example of a driving method for acquiring the ranging frame F (also referred to as the distance image), the sub-frames SF, and the micro-frames MF.

In the flowchart illustrated in FIG. 11, a series of processing from "START" to "END" illustrates a series of processing for generating a distance moving image by repeating L times the ranging frame period T1 of acquiring the ranging frame F. One round of processing in the loop from step S102 to step S108 is a processing performed in a sub-frame period T2 in which one sub-frame SFm (m=1, 2, 3, ... , and M) in FIG. 8 is acquired. One round of processing in the loop from step S103 to step S105 is a processing performed in a micro-frame period T3 in which one micro-frame MFn (n=1, 2, 3, ... , and N) in FIG. 8 is acquired.

First, in step S101, the ranging device control unit 180 performs predetermined operation setting and starts light emission and exposure driving. That is, the ranging device control unit 180 transmits a setting value for determining the operation of the photodetection device 120 to the operation setting unit 132. For example, the ranging device control unit 180 transmits setting values such as an operation mode of the photodetection device 120, a gain, a white balance, and the like to the operation setting unit 132. In addition, the ranging device control unit 180 controls the light source device 110 via the ranging pulse generation unit 130 to irradiate the irradiation pulsed light 116 to the measurement target region. In addition, the ranging device control unit 180 controls the photodetection device 120 in synchronization with the control of the light source device 110 and starts imaging by global gate driving. At this time, the ranging pulse generation unit 130 outputs the gate signal corresponding to the set gating period to the photodetection device 120.

Next, in step S102, the ranging device control unit 180 initializes the variable i used for counting the micro-frames MFn (n=1, 2, 3, ... , and N) constituting one sub-frame SFm (m=1, 2, 3, ... , and M) to 1. As for the number of micro-frames MFn (n=1, 2, 3, ... , and N) constituting one sub-frame SFm (m=1, 2, 3, ... , and M), the larger the value of N is, the better the signal-to-noise (S/N) ratio becomes, but the light detection accuracy deteriorates. In the present embodiment, 16 or 64 is assumed as the value of N. However, the value of N may be other than those.

Next, in step S103, the MF addition unit 170 reads out the micro-frame MF from the photodetection device 120 and integrates the micro-frame MF into the previously read out value. That is, after a predetermined micro-frame period T3 elapses, the photodetection device 120 outputs a micro-frame MF of a one-bit signal held by the MF holding unit 36A or the MF holding unit 36B from each pixel 30. The micro-frame MF read out from the photodetection device 120 is output to the MF addition unit 170 and integrated in the MF addition unit 170. As described above, the MF addition unit 170 may be constituted by the half adder, the full adder, the selector, and the memory. The memory has a storage capacity capable of holding multi-bit data for each pixel. Every time the micro-frame MF is read out from the photodetection device 120, the MF addition unit 170 adds the read-out value to the value held in the memory and stores the integrated value. As described above, the MF addition unit 170 functions as a composition unit that composites the micro-frames MF acquired in different periods.

Next, in step S104, it is determined whether or not the number of acquired micro-frames MF (variable i) has reached a predetermined value (N). As a result of the determination, if the number of acquired micro-frames MF (variable i) has not reached the predetermined value (N) ("NO" in step S104), the variable i is incremented by 1 in step S105, and the process returns to step S103. As a result of the determination, if the number of acquired micro-frames MF (variable i) is a predetermined value (N) ("YES" in step S104), the process proceeds to step S106. At this time, data (sub-frame SF) obtained by accumulating the values of the N-number of micro-frames MF is held in the memory of the MF addition unit 170. For example, when N is 64, the sub-frame SF is 6-bit gradation data.

Next, in step S106, the MF addition unit 170 transmits the sub-frame SF generated by accumulating the values of the N-number of micro-frames to the SF storage unit 172. The SF storage unit 172 stores the sub-frame SF received from the MF addition unit 170. The SF storage unit 172 is configured to be capable of individually storing a plurality of sub-frames SF used to generate one ranging frame F for each sub-frame SF.

Next, in step S107, it is determined whether or not all (M-number of) sub-frames SF corresponding to each of the measurement target distances constituting one ranging frame F have been acquired. As a result of the determination, if all the sub-frames SF constituting the ranging frame F have not been acquired ("NO" in step S107), the gating period is shifted to a gating period corresponding to another measurement target distance range in step S108, and the process returns to step S102. For example, the measurement target distance range may be sequentially shifted from the measurement closest to the ranging device 100 to the farthest side. As a result of the determination, if all the sub-frames constituting the ranging frame F are acquired ("YES" in step S107), the process proceeds to step S109. At this time, M-number of sub-frames SF constituting one ranging frame F are held in the SF storage unit 172.

Next, in step S109, the determination unit 140 determines whether it is necessary to change the operation setting and the light emission/exposure driving based on the signal values of the M-number of sub-frames SF stored in the SF storage unit 172. The determination unit 140 transmits the determination result to the ranging device control unit 180 and the distance image generation unit 174. Details of the determination processing in the determination unit 140 will be described later.

Next, in step S110, the distance image generation unit 174 acquires the plurality of sub-frames SF in one ranging frame F from the SF storage unit 172. The distance image generation unit 174 calculates a sub-frame SF having the largest signal value for each pixel 30 and calculates a measurement target distance range corresponding to the calculated sub-frame. That is, the distance image generation unit 174 determines the thus calculated measurement target distance range or the class value thereof as the distance measurement result of the object in the pixel. In this way, the distance image generation unit 174 generates distance image data indicating a two-dimensional distribution of distances. The distance image generation unit 174 adds the determination signal received from the determination unit 140 to the generated distance image data as attribute information and transmits the distance image data including the attribute information to the distance moving image generation unit 176.

Note that step S109 and step S110 need not necessarily be performed sequentially, and at least a part of the processing in step S109 and at least a part of the processing in step S110 may be performed in parallel.

Next, in step S111, the distance moving image generation unit 176 determines whether or not acquisition of all (L-number of) distance images corresponding to each of the measurement target distances constituting the distance moving image is completed. As a result of the determination, if all the distance images constituting the distance moving image have not been acquired ("NO" in step S111), the process returns to step S101. As a result of the determination, if all the distance images constituting the distance moving image are acquired ("YES" in step S111), the process proceeds to step S112.

Next, in step S112, the distance moving image generation unit 176 generates a distance moving image by compositing the L-number of distance images. At this time, the distance moving image generation unit 176 refers to the attribute information added to the distance image data, and determines whether or not the target distance image is an image constituted by a sub-frame group in which it is determined that it is necessary to change the operation setting or the light emission/exposure driving. As a result of the determination, when the target distance image is an image constituted by a sub-frame group determined to require the operation setting or the change of the light emission/exposure driving, the image is not used for the composition of the distance moving image. Instead, a distance image determined to require no change in the operation setting or the light emission/exposure driving that is constituted by a sub-frame group immediately preceding or immediately following thereof is used to composite the distance moving image.

In this way, by a series of operations from step S101 to step S112, one sub-frame SF acquired from N-number of micro-frames MF, one distance image acquired from M-number of sub-frames SF, and one distance moving image acquired from L-number of distance images are sequentially acquired.

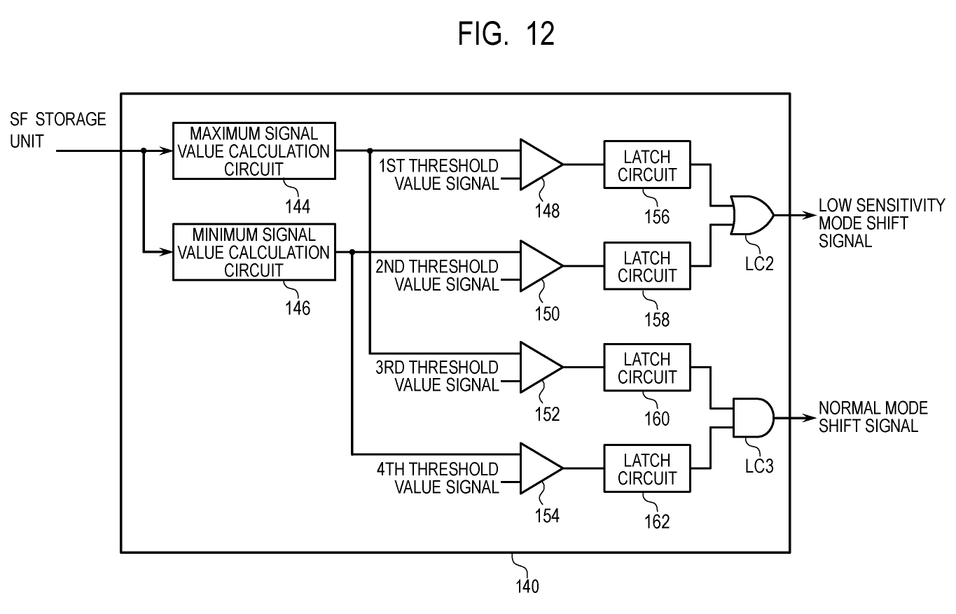

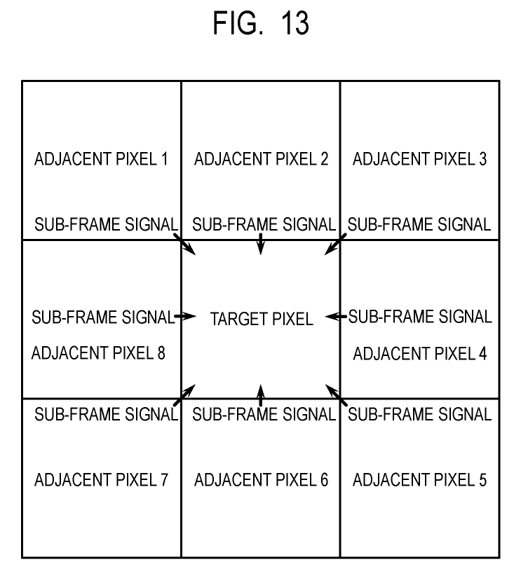

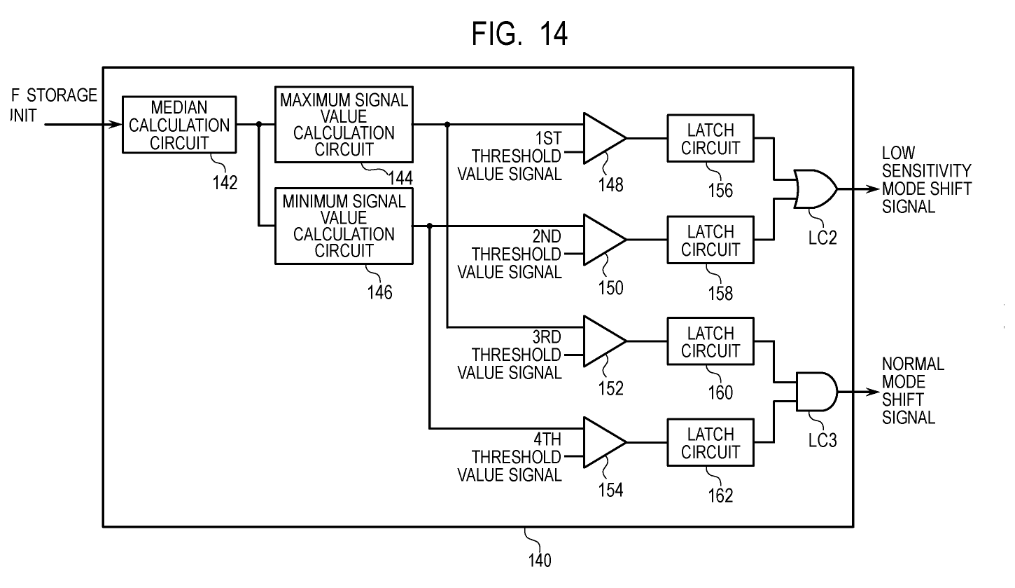

Next, a configuration example of the determination unit 140 will be described with reference to FIGS. 12-14. FIG. 12 is a block diagram illustrating a configuration example of the determination unit 140. FIG. 13 is a diagram illustrating an example of a method of calculating a maximum signal value and a minimum signal value. FIG. 14 is a block diagram illustrating another configuration example of the determination unit 140.

The determination unit 140 has a function of performing saturation determination of the signal value of the sub-frame SF stored in the SF storage unit 172 and outputting a low sensitivity mode shift signal or a normal mode shift signal to the ranging device control unit 180 according to the result of the saturation determination. The low sensitivity mode shift signal is a signal for instructing a shift of the operation mode from a normal mode to a low sensitivity mode. The normal mode shift signal is a signal for instructing shift of the operation mode from the low sensitivity mode to the normal mode. The low sensitivity mode is an operation mode set to an operation condition having lower sensitivity than the normal mode, and the normal mode is an operation mode set to an operation condition having higher sensitivity than the low sensitivity mode.

When saturation occurs in the signal value, the distance measurement accuracy decreases. For example, in a case where the signal value is saturated by the external light, the signal and the external light cannot be separated from each other, and the distance measurement accuracy may decrease. Further, when the signal value is saturated by the signal based on the reflected light from the object, the accuracy of the interpolation and fitting processing of the depth data is deteriorated, and there is a possibility that the distance measurement accuracy is decreased. From such a viewpoint, in the ranging device 100 of the present embodiment, the determination unit 140 performs saturation determination of the signal value and changes the operation condition as necessary.

As illustrated in, e.g., FIG. 12, the determination unit 140 includes a maximum signal value calculation circuit 144, a minimum signal value calculation circuit 146, a comparator 148, 150, 152 and 154, a latch circuit 156, 158, 160 and 162, an OR circuit LC2, and an AND circuit LC3. Each of the comparators 148, 150, 152 and 154 has two input nodes and one output node. The OR circuit LC2 may be a two-input OR circuit. The AND circuit LC3 may be a two-input AND circuit.

The maximum signal value calculation circuit 144 and the minimum signal value calculation circuit 146 are connected to the SF storage unit 172. One input node of each of the comparators 148 and 152 is connected to the maximum signal value calculation circuit 144. One input node of each of the comparators 150 and 154 is connected to the minimum signal value calculation circuit 146. A first threshold value signal is input to the other input node of the comparator 148. A second threshold value signal is input to the other input node of the comparator 150. A third threshold value signal is input to the other input node of the comparator 152. A fourth threshold value signal is input to the other input node of the comparator 154. An output node of the comparator 148 is connected to an input node of the latch circuit 156. An output node of the comparator 150 is connected to an input node of the latch circuit 158. An output node of the comparator 152 is connected to an input node of the latch circuit 160. An output node of the comparator 154 is connected to an input node of the latch circuit 162. An output node of the latch circuit 156 and an output node of the latch circuit 158 are connected to two input nodes of the OR circuit LC2. An output node of the latch circuit 160 and an output node of the latch circuit 162 are connected to two input nodes of the AND circuit LC3. An output signal of the OR circuit LC2 is the low sensitivity mode shift signal, and an output signal of the AND circuit LC3 is a normal mode shift signal.

The determination unit 140 reads out the signal values of the sub-frames SF stored in the SF storage unit 172. The signal values of the sub-frames SF read out from the SF storage unit 172 are input to the maximum signal value calculation circuit 144 and the minimum signal value calculation circuit 146. The maximum signal value calculation circuit 144 calculates the maximum signal value from the read-out signal values of the sub-frames SF. Further, the minimum signal value calculation circuit 146 calculates the minimum signal value from the signal values of the read-out sub-frames SF. The internal configurations of the maximum signal value calculation circuit 144 and the minimum signal value calculation circuit 146 are not particularly limited as long as the maximum signal value or the minimum signal value may be calculated from the signal values of the sub-frames SF acquired from the SF storage unit 172. For example, the maximum signal value calculation circuit 144 and the minimum signal value calculation circuit 146 may be constituted by combining a plurality of comparators in multiple stages so as to compare the signal values of the sub-frame SF read out from the SF storage unit 172 in a brute-force manner.

The calculation of the maximum signal value in the maximum signal value calculation circuit 144 and the calculation of the minimum signal value in the minimum signal value calculation circuit 146 are not necessarily performed for each pixel 30, and the signal values of the sub-frames SF of the adjacent pixel 30 may be further considered. For example, as illustrated in FIG. 13, the median value of the sub-frames SF at each gate position is calculated in nine pixels 30 including the target pixel to be determined and eight adjacent pixels around the target pixel. Then, the calculated median value of the sub-frames SF at each gate position is input to the maximum signal value calculation circuit 144 and the minimum signal value calculation circuit 146 of the target pixel, and the maximum signal value and the minimum signal value are calculated. For example, as illustrated in FIG. 14, the median value of the sub-frames SF may be calculated by a median value calculation circuit 142 connected to the preceding stage of the maximum signal value calculation circuit 144 and the minimum signal value calculation circuit 146. In the case of adopting this configuration, since the maximum signal value and the minimum signal value are calculated using the signal values of the sub-frames SF of the adjacent pixels, it is possible to suppress the accuracy error of calculation due to the outlier, and it is possible to further improve the determination accuracy in the determination unit 140.

Next, the low sensitivity mode shift determination operation using the comparators 148 and 150, the latch circuits 156 and 158, and the OR circuit LC2 will be described. In the low sensitivity mode shift determination, it is determined whether or not the signal values of all the sub-frames SF are in a saturated state due to the influence of external light and accurate distance measurement cannot be performed, or the signal values are in a saturated state immediately at the time of object detection due to too high sensitivity and accurate distance measurement cannot be performed.

The first threshold value signal and the second threshold value signal are used in the low sensitivity mode shift determination. More specifically, it is determined whether or not saturation of the signal value occurs in the sub-frame SF using the first threshold value signal. The second threshold value signal is used to determine whether or not saturation due to external light has occurred in the acquired sub-frame SF. The first threshold value is a saturation determination value used to determine signal saturation. Therefore, the first threshold value is set to a value near the maximum value that the sub-frame SF can take. The second threshold value is used to determine whether or not the minimum value of the sub-frames SF is raised by the external light and thus saturation occurs in the sub-frame SF. Therefore, the second threshold value is set to a value sufficiently smaller than the first threshold value. Specifically, the second threshold value may be set to a value slightly smaller than the intermediate value of the signal that the sub-frame SF can take.

Hereinafter, the operation of the low sensitivity mode shift determination will be described in more detail. The signal value calculated by the maximum signal value calculation circuit 144 is input to the comparator 148 and compared with the first threshold value. As a result of the comparison in the comparator 148, in a case where the signal value calculated by the maximum signal value calculation circuit 144 is equal to or larger than the first threshold value, the comparator 148 outputs "1" to the latch circuit 156. As a result of the comparison in the comparator 148, in a case where the signal value calculated by the maximum signal value calculation circuit 144 is less than the first threshold value, the comparator 148 outputs "0" to the latch circuit 156. Here, it is assumed that the signal level "1" indicates an active state and the signal level "0" indicates an inactive state. The latch circuit 156 maintains the output of the signal value in the previous state in a case where "0" is input from the comparator 148 and outputs "1" to the OR circuit LC2 until it is reset in a case where "1" is input from the comparator 148. By this operation, it is possible to determine whether or not the sensitivity is too high and the signal value is not immediately saturated.

In parallel with this operation, the signal value calculated by the minimum signal value calculation circuit 146 is input to the comparator 150 and compared with the second threshold value. As a result of the comparison in the comparator 150, in a case where the signal value calculated by the minimum signal value calculation circuit 146 is equal to or larger than the second threshold value, the comparator 150 outputs "1" to the latch circuit 158. As a result of the comparison in the comparator 150, in a case where the signal value calculated by the minimum signal value calculation circuit 146 is less than the second threshold value, the comparator 150 outputs "0" to the latch circuit 158. The latch circuit 158 maintains the output of the signal value in the previous state in a case where "0" is input from the comparator 150 and outputs "1" to the OR circuit LC2 until it is reset in a case where "1" is input from the comparator 150. By this operation, it is possible to determine whether or not the signal values of all the sub-frames SF are in a saturated state due to the influence of external light.

The output signals of the latch circuits 156 and 158 are input to the OR circuit LC2. In a case where at least one of the outputs of the latch circuits 156 and 158 is "1", the OR circuit LC2 outputs "1" as the low sensitivity mode shift signal. In a case where the outputs of the latch circuits 156 and 158 are other than those, the OR circuit LC2 outputs "0" as the low sensitivity mode shift signal. In a case where the low sensitivity mode shift signal is "1", the sensitivity of the external light or the signal value is too high to deteriorate the distance measurement accuracy, and thus the next distance image acquisition is controlled to be performed in a state where the sensitivity is lowered.

Next, the operation of the normal mode shift determination using the comparators 152 and 154, the latch circuits 160 and 162, and the AND circuit LC3 will be described. In the normal mode shift determination, it is determined whether or not the signal values of all the sub-frames SF are in a state of indicating a low value without the influence of external light, and the signal values are in a state of indicating an unsaturated and low value even at the time of object detection.

The third threshold value signal and the fourth threshold value signal are used in the normal mode shift determination. More specifically, the third threshold value signal is used to determine whether or not saturation due to the signal does not occur in the sub-frame SF even when the mode is shifted to the normal mode. Further, the fourth threshold value signal is used to determine whether or not saturation due to external light does not occur even when the mode is shifted to the normal mode. Since the third threshold value is a threshold value for determining that signal saturation does not occur even when the mode is shifted to the normal mode, the third threshold value is set to a value lower than an intermediate value of values that the sub-frame SF can take. Since the fourth threshold value is a threshold value for determining saturation due to external light, the fourth threshold value is set to a value sufficiently smaller than the third threshold value for determining saturation due to a signal including the influence of external light.

Hereinafter, the operation of the normal mode shift determination will be described in more detail. The signal value calculated by the maximum signal value calculation circuit 144 is input to the comparator 152 and compared with the third threshold value. As a result of the comparison in the comparator 152, in a case where the signal value calculated by the maximum signal value calculation circuit 144 is less than the third threshold value, the comparator 152 outputs "1" to the latch circuit 160. As a result of the comparison in the comparator 152, in a case where the signal value calculated by the maximum signal value calculation circuit 144 is equal to or larger than the third threshold value, the comparator 152 outputs "0" to the latch circuit 160. The latch circuit 160 maintains the output of the signal value in the previous state in a case where "0" is input from the comparator 152, and outputs "1" to the AND circuit LC3 until it is reset when "1" is input from the comparator 152. By this operation, it is possible to determine whether or not the signal value is not saturated and is a sufficiently low value even at the time of object detection.

In parallel with this operation, the signal value calculated by the minimum signal value calculation circuit 146 is input to the comparator 154 and compared with the fourth threshold value. As a result of the comparison in the comparator 154, in a case where the signal value calculated by the minimum signal value calculation circuit 146 is less than the fourth threshold value, the comparator 154 outputs "1" to the latch circuit 162. As a result of the comparison in the comparator 154, in a case where the signal value calculated by the minimum signal value calculation circuit 146 is equal to or larger than the fourth threshold value, the comparator 154 outputs "0" to the latch circuit 162. The latch circuit 162 maintains the output of the signal value in the previous state when "0" is input from the comparator 154, and outputs "1" to the AND circuit LC3 until it is reset in a case where "1" is input from the comparator 154. This operation makes it possible to determine whether or not the influence of external light is at a sufficiently low level.

The output signals of the latch circuits 160 and 162 are input to the AND circuit LC3. In a case where both the output of the latch circuit 160 and the output of the latch circuit 162 are "1", the AND circuit LC3 outputs "1" as the normal mode shift signal. In a case where the outputs of the latch circuits 160 and 162 are other than those, the AND circuit LC3 outputs "0" as the normal mode shift signal. In a case where the normal mode shift signal is "1", since the influence of external light is small and the signal value at the time of the object detection is an unsaturated state and low, the next distance image acquisition is controlled to be performed in the normal mode.

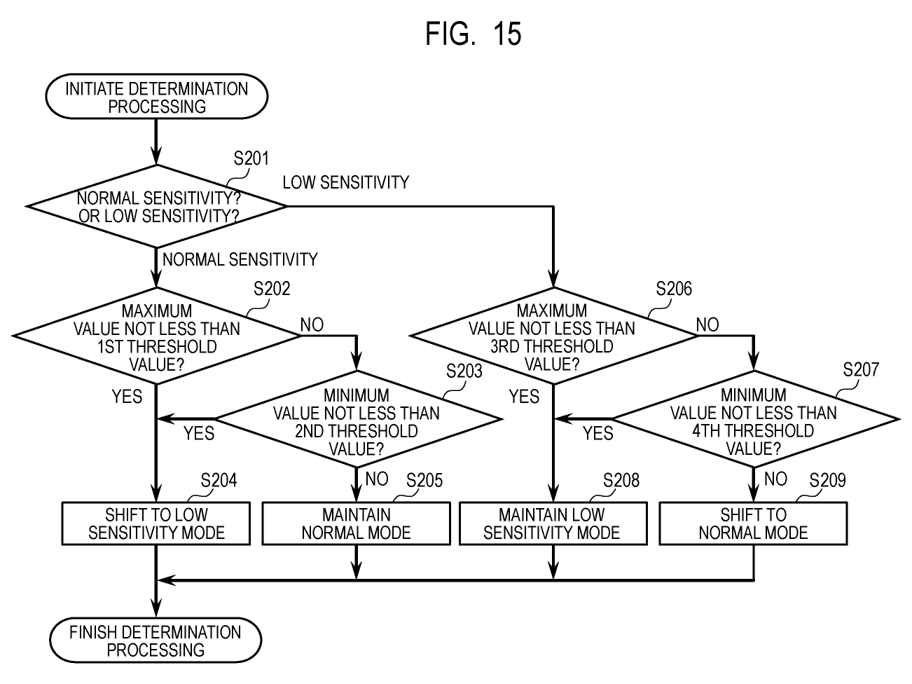

Next, the flow of determination processing in the determination unit 140 will be described in more detail with reference to FIG. 15. FIG. 15 is a flowchart illustrating a determination processing method in the determination unit 140. A series of steps illustrated in FIG. 15 is performed in step S109 in FIG. 11.

First, in step S201, the determination unit 140 determines whether the current operation mode is the normal mode of the normal sensitivity setting or the low sensitivity mode of the low sensitivity setting. As a result of the determination, in a case where the current operation mode is the normal mode, the process proceeds to step S202, and in a case where the current operation mode is the low sensitivity mode, the process proceeds to step S206.

In step S202, the determination unit 140 determines whether or not the maximum value of the sub-frames SF is equal to or larger than the first threshold value. As described above, the first threshold value is used as a reference for determining whether or not the signal value of the sub-frame is in the saturated state at the time of object detection. For example, assuming a case where the sub-frame is constituted by six micro-frames, the sub-frame has a 6-bit gradation width (0 to 63). In this case, a value of about 60 may be assumed as the first threshold value. As a result of the determination, in a case where the maximum value of the sub-frames is equal to or larger than the first threshold value ("YES" in step S202), the process proceeds to step S204. As a result of the determination, in a case where the maximum value of the sub-frames is less than the first threshold value ("NO" in step S202), the process proceeds to step S203.

In step S203, the determination unit 140 determines whether or not the minimum value of the sub-frames SF is equal to or larger than the second threshold value. As described above, the second threshold value is used as a reference for determining whether signal values of all sub-frames are saturated due to the influence of external light. Assuming a case where the sub-frame is constituted by six micro-frames (0 to 63 gradations), a value of about 48 may be assumed as the second threshold value. As a result of the determination, in a case where the minimum value of the sub-frames SF is equal to or larger than the second threshold value ("YES" in step S203), the process proceeds to step S204. As a result of the determination, in a case where the minimum value of the sub-frames SF is less than the second threshold value ("NO" in step S203), the process proceeds to step S205.

In this way, in a case where the maximum value of the sub-frames SF is equal to or larger than the first threshold value or the minimum value of the sub-frames SF is equal to or larger than the second threshold value, the process proceeds to step S204. In step S204, the determination unit 140 determines to perform the next distance image acquisition in the low sensitivity mode and ends the determination process of step S109.

In a case where the minimum value of the sub-frames SF is less than the second threshold value, the process proceeds to step S205. In step S205, the determination unit 140 determines to continue the next distance image acquisition in the normal mode and ends the determination process of step S109.

In step S206, the determination unit 140 determines whether or not the maximum value of the sub-frames SF is equal to or larger than the third threshold value. As described above, the third threshold value is used as a reference for determining whether the signal value of the sub-frame is in the non-saturated state and is a low value at the time of object detection. Assuming a case where the sub-frame is constituted by six micro-frames (0 to 63 gradations), a value of about 16 may be assumed as the third threshold value. As a result of the determination, in a case where the maximum value of the sub-frames SF is less than the third threshold value ("NO" in step S206), the process proceeds to step S207. As a result of the determination, in a case where the maximum value of the sub-frames SF is equal to or larger than the third threshold value ("YES" in step S206), the process proceeds to step S208.

In step S207, the determination unit 140 determines whether or not the minimum value of the sub-frames SF is equal to or larger than the fourth threshold value. As described above, the fourth threshold value is used as a reference for determining whether or not the signal values of all the sub-frames are in the non-saturated state without the influence of the external light. Assuming a case where the sub-frame is constituted by six micro-frames (0 to 63 gradations), a value of about 8 may be assumed as the fourth threshold value. As a result of the determination, in a case where the minimum value of the sub-frames SF is less than the fourth threshold value ("NO" in step S207), the process proceeds to step S209. As a result of the determination, in a case where the minimum value of the sub-frames SF is equal to or larger than the fourth threshold value ("YES" in step S207), the process proceeds to step S208.

In this way, in a case where the maximum value of the sub-frames SF is less than the third threshold value and the minimum value of the sub-frames SF is less than the fourth threshold value, the process proceeds to step S209. In step S209, the determination unit 140 determines to perform the next distance image acquisition in the normal mode and ends the determination process of step S109.

In a case where the maximum value of the sub-frames SF is equal to or larger than the third threshold value or the minimum value of the sub-frames SF is equal to or larger than the fourth threshold value, the process proceeds to step S208. In step S208, the determination unit 140 determines to continue the next distance image acquisition in the low sensitivity mode and ends the determination process of step S109.

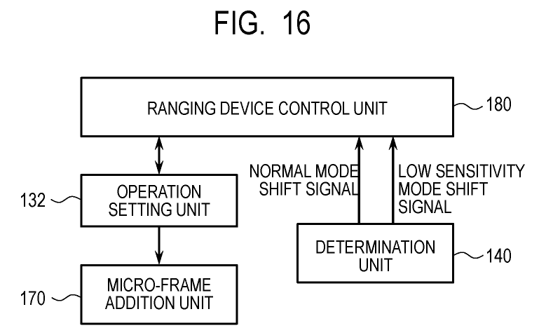

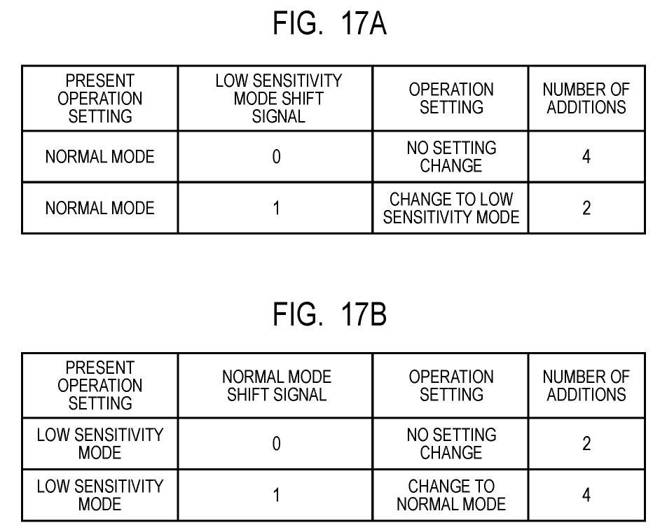

Next, the control operation of the ranging device control unit 180 based on the determination result of the determination unit 140 will be described with reference to FIGS. 16-17B. FIG. 16 is a diagram explaining the flow of a control operation by the ranging device control unit 180 based on the determination result of the determination unit 140. FIGS. 17A and 17B are diagrams illustrating examples of changing the operation setting by the ranging device control unit 180.

First, the ranging device control unit 180 reads out the current operation mode from the operation setting unit 132. In a case where the current operation mode read out from the operation setting unit 132 is the normal mode, the ranging device control unit 180 refers to the low sensitivity mode shift signal acquired from the determination unit 140. In a case where the signal level of the low sensitivity mode shift signal referred to is "1", the ranging device control unit 180 performs the shift control to the low sensitivity mode. For example, in a case where the number of times of addition of the micro-frames MF in the normal mode is four, the ranging device control unit 180 shifts to the low sensitivity mode by changing the number of times of addition of the micro-frames MF in the MF addition unit 170 to two via the operation setting unit 132. In a case where the signal level of the acquired low sensitivity mode shift signal is "0", the ranging device control unit 180 does not perform the shift control of the operation mode. FIG. 17A summarizes the changing conditions of the operation setting in the normal mode.

In a case where the current operation mode read out from the operation setting unit 132 is the low sensitivity mode, the ranging device control unit 180 refers to the normal mode shift signal acquired from the determination unit 140. In a case where the signal level of the referenced normal mode shift signal is "1", the ranging device control unit 180 performs the shift control to the normal mode. For example, in a case where the number of times of addition of the micro-frame MF in the low sensitivity mode is two, the ranging device control unit 180 shifts to the normal mode by changing the number of times of addition of the micro-frames MF in the MF addition unit 170 to four via the operation setting unit 132. In a case where the signal level of the acquired normal mode shift signal is "0", the ranging device control unit 180 does not perform the shift control of the operation mode. FIG. 17B summarizes the changing conditions of the operation setting in the low sensitivity mode.

Here, the number of times of addition of the micro-frames MF in the normal mode is set to four, and the number of times of addition of the micro-frames MF in the low sensitivity mode is set to two, but the number of times of addition of the micro-frames MF is not limited thereto. The number of additions of the micro-frames MF may be larger in the normal mode than in the low sensitivity mode and may be arbitrary as long as this relationship is satisfied.

As described above, in the present embodiment, the determination unit 140 calculates the maximum value and the minimum value of the acquired sub-frames SF and compares the maximum value and the minimum value with a predetermined threshold value to determine whether the sub-frames SF are in the saturation state or the non-saturation state. More specifically, first, at the timing of generating the distance image, it is determined whether or not the distance image generated from the plurality of sub-frames SF is saturated using the signal values of the plurality of sub-frames SF. As a result of the determination, in the case of the saturation state, operation control of reducing the number of times of addition in the MF addition unit 170 is performed. As a result of the determination, in the case of the non-saturated state, operation control of increasing the number of times of addition in the MF addition unit 170 is performed. As a result, the signal value level of the sub-frame SF may be maintained in an appropriate state, and deterioration of the distance measurement accuracy due to saturation may be suppressed.

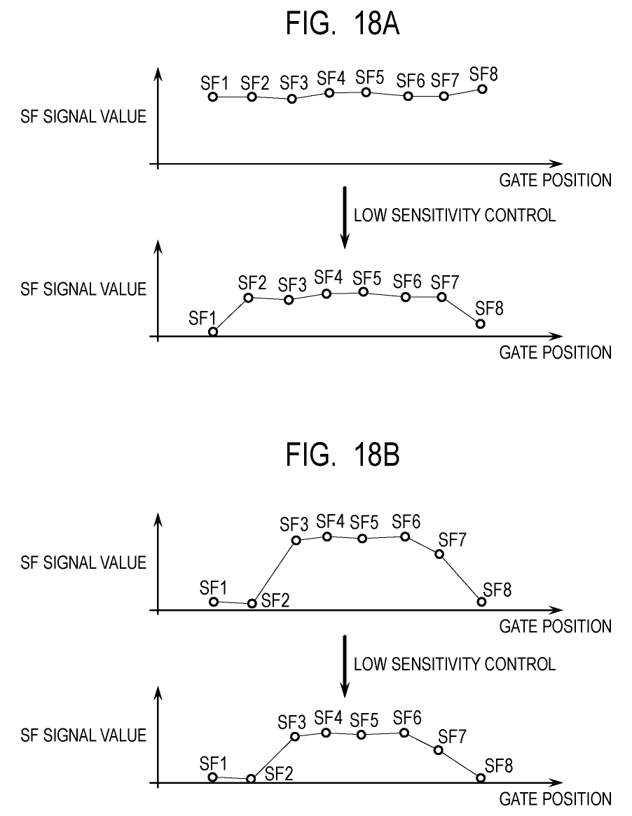

FIGS. 18A and 18B are diagrams explaining effects of the present embodiment. FIGS. 18A and 18B illustrate two operation examples when the normal mode is shifted to the low sensitivity mode in the saturation state.

The upper part of FIG. 18A illustrates the distribution of the signal values of the sub-frames SF in the case where saturation due to external light occurs. In the upper part of FIG. 18A, the signal and the external light cannot be separated from each other, and there is a concern that the distance error increases. By shifting from this state to the low sensitivity mode, as illustrated in the lower part of FIG. 18A, the signal and the external light may be separated from each other, and the distance error may be reduced.

The upper part of FIG. 18B illustrates the distribution of the signal values of the sub-frames SF when saturation occurs due to the signal. In a case where saturation due to the signal occurs, there is a possibility that a signal value has reached an upper limit in any of the saturated sub-frames SF, and there is a concern that accuracy of depth data deteriorates. By shifting from this state to the low sensitivity mode, as illustrated in the lower part of FIG. 18B, it is possible to suppress the reaching to the upper limit of the signal value and reduce the distance error.

As described above, according to the present embodiment, in the time gate type ranging device, since the saturation determination is performed based on the signal values of the sub-frames and the result is fed back to the operation condition, it is possible to suppress the deterioration of the ranging accuracy due to the saturation of the signal value.

### Second Embodiment

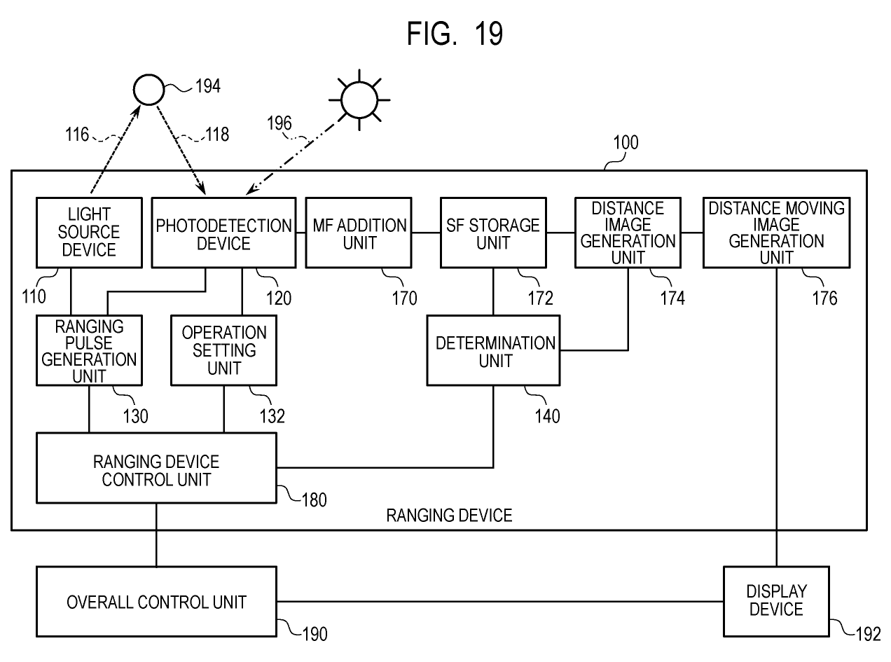

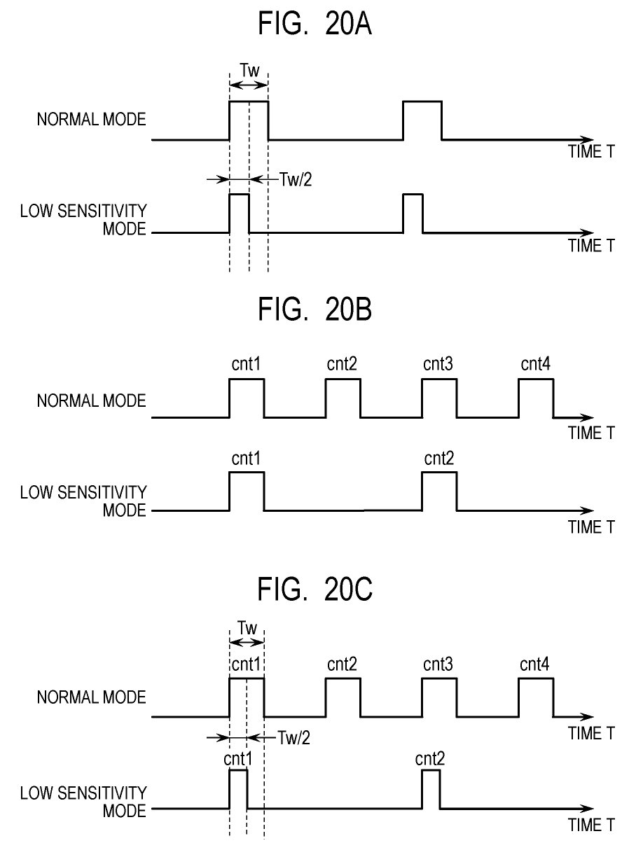

A ranging system according to a second embodiment will be described with reference to FIGS. 19-20C. The same components as those of the ranging system according to the first embodiment are denoted by the same reference numerals, and description thereof will be omitted or simplified.

FIG. 19 is a block diagram illustrating a schematic configuration of a ranging system according to the present embodiment. As illustrated in FIG. 19, the basic configuration of the ranging system according to the present embodiment is the same as that of the ranging system according to the first embodiment. The ranging system according to the present embodiment is different from the ranging system according to the first embodiment in that the operation setting unit 132 does not control the number of times of addition of the micro-frames MF in the MF addition unit 170. Therefore, in FIG. 19, a control signal line for the operation setting unit 132 to control the MF addition unit is omitted.

In the present embodiment, instead of switching between the normal mode and the low sensitivity mode according to the number of additions of the micro-frames MF, the normal mode and the low sensitivity mode are switched according to the pulse width or the number of pulses (the number of toggles of the signal) of the gate signal. The other points except for the operation of the ranging device control unit 180 at the time of mode switching are the same as those in the first embodiment.

Next, a mode switching operation in the ranging system according to the present embodiment will be described with reference to FIGS. 20A-20C. FIGS. 20A-20C are diagrams illustrating a mode switching operation in the ranging system according to the present embodiment. FIGS. 20A-20C illustrate three methods as the operation at the time of mode switching.

The first method is a method of changing the pulse width of the gate signal when switching between the normal mode and the low sensitivity mode. That is, in the case of shifting from the normal mode to the low sensitivity mode, the ranging device control unit 180 sets the pulse width of the gate signal to be narrower than that in the normal mode when instructing the ranging pulse generation unit 130 to generate the gate signal. For example, as illustrated in FIG. 20A, in a case where the pulse width of the gate signal in the normal mode is Tw, the pulse width of the gate signal in the low sensitivity mode may be set to Tw/2, which is 50% in the normal mode. In the case of shifting from the low sensitivity mode to the normal mode, the ranging device control unit 180 sets the pulse width of the gate signal to be wider than that in the low sensitivity mode when instructing the ranging pulse generation unit 130 to generate the gate signal. For example, as illustrated in FIG. 20A, in a case where the pulse width of the gate signal in the low sensitivity mode is Tw/2, the pulse width of the gate signal in the normal mode may be set to Tw which is 200% in the low sensitivity mode. Since the length of the exposure period of the reflected pulsed light 118 is changed by changing the pulse width of the gate signal, the sensitivity may be changed. Here, the pulse width of the gate signal in the low sensitivity mode is 50% of the pulse width of the gate signal in the normal mode, but the pulse width of the gate signal in the low sensitivity mode is not particularly limited as long as it is narrower than the pulse width of the gate signal in the normal mode.

The second method is a method of changing the frequency of pulses of the gate signal (the number of pulses per micro-frame MF) when switching between the normal mode and the low sensitivity mode. That is, in the case of shifting from the normal mode to the low sensitivity mode, the ranging device control unit 180 sets the number of pulses of the gate signal to be smaller than that in the normal mode when instructing the ranging pulse generation unit 130 to generate the gate signal. For example, as illustrated in FIG. 20B, the number of pulses of the gate signal in the low sensitivity mode may be set to half the number of pulses in the normal mode. In the case of shifting from the low sensitivity mode to the normal mode, the ranging device control unit 180 sets the number of pulses of the gate signal to be larger than that in the low sensitivity mode when instructing the ranging pulse generation unit 130 to generate the gate signal. For example, as illustrated in FIG. 20B, the number of pulses of the gate signal in the normal mode may be set to be twice the number of pulses in the low sensitivity mode. Here, the number of pulses of the gate signal in the low sensitivity mode is half of the number of pulses of the gate signal in the normal mode, but the number of pulses of the gate signal in the low sensitivity mode is not particularly limited as long as it is smaller than the number of pulses of the gate signal in the normal mode.

The third method is a combination of the first method and the second method. That is, in the third method, when switching between the normal mode and the low sensitivity mode, as illustrated in FIG. 20C, both the pulse width and the number of pulses of the gate signal are changed. The method of changing the pulse width and the number of pulses of the gate signal may be the same as the first method and the second method. However, in the third method, it is sufficient that the sensitivity may be changed as a whole to a desired sensitivity by changing both the pulse width and the number of pulses of the gate signal, and the pulse width and the number of pulses of the gate signal do not necessarily need to be changed in the same direction.

In the present embodiment, the determination unit 140 determines whether the gate signal is in the saturation state or the non-saturation state, and the pulse width of the gate signal and/or the number of pulses (that is, the length of the exposure period) is controlled according to the determination result. Therefore, it is possible to maintain the signal value level of the sub-frame SF in an appropriate state, and it is possible to suppress deterioration of the distance measurement accuracy due to saturation.

As described above, according to the present embodiment, in the time gate type ranging device, since the saturation determination is performed based on the signal values of the sub-frames and the result is fed back to the operation condition, it is possible to suppress the deterioration of the ranging accuracy due to the saturation of the signal value.

### Third Embodiment

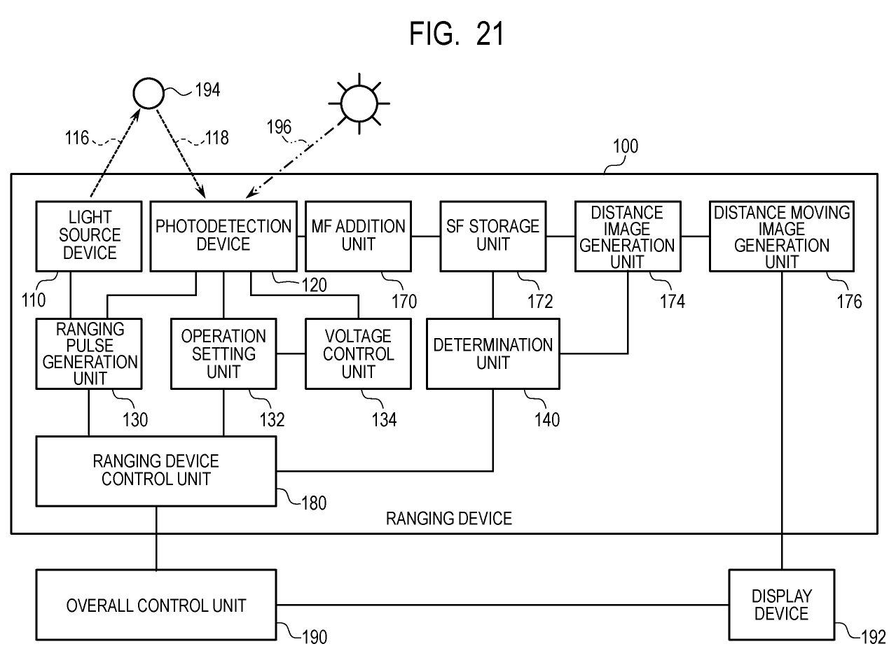

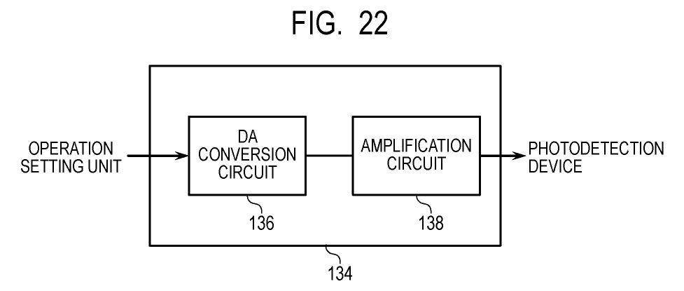

A ranging system according to a third embodiment will be described with reference to FIGS. 21 and 22. The same components as those of the ranging system according to the first or second embodiment are denoted by the same reference numerals, and description thereof will be omitted or simplified.

The ranging system according to the present embodiment is different from the ranging system according to the first or second embodiment in the configuration of the ranging device 100. FIG. 21 is a block diagram illustrating a schematic configuration of a ranging system according to the present embodiment. As illustrated in FIG. 21, the ranging device 100 of the ranging system according to the present embodiment further includes a voltage control unit 134. The voltage control unit 134 is connected to the operation setting unit 132 and the photodetection device 120.

As illustrated in, e.g., FIG. 22, the voltage control unit 134 may include a digital-to-analog (DA) conversion circuit 136 and an amplifier circuit 138. The DA conversion circuit 136 is connected to the operation setting unit 132. The amplifier circuit 138 is connected to the DA conversion circuit 136 and the photodetection device 120. The voltage control unit 134 is a circuit that controls the voltage VL supplied to the photodetection device 120 in accordance with a setting signal from the operation setting unit 132. That is, the voltage VL supplied from the voltage control unit 134 to the photodetection device 120 may be variably controlled by changing the value of the setting signal output from the operation setting unit 132.

In the present embodiment, the normal mode and the low sensitivity mode are switched by changing the voltage VL supplied to the photodetection device 120. That is, when shifting from the normal mode to the low sensitivity mode, the ranging device control unit 180 transmits a setting signal for shifting the voltage level (absolute value) of the voltage VL in a direction of decreasing the voltage level to the voltage control unit 134 via the operation setting unit 132. Thus, the absolute value of the drive voltage applied to the photoelectric conversion element PD is reduced, so that the sensitivity of the photodetection device 120 may be reduced. When shifting from the low sensitivity mode to the normal mode, the ranging device control unit 180 transmits a setting signal for shifting the voltage level (absolute value) of the voltage VL in a direction in which the voltage level (absolute value) increases, to the voltage control unit 134 via the operation setting unit 132. Thus, the absolute value of the drive voltage applied to the photoelectric conversion element PD is increased, so that the sensitivity of the photodetection device 120 may be increased. The other points except for the operation of the ranging device control unit 180 at the time of mode switching are the same as those of the first or second embodiment.

As described above, according to the present embodiment, in the time gate type ranging device, since the saturation determination is performed based on the signal values of the sub-frames and the result is fed back to the operation condition, it is possible to suppress the deterioration of the ranging accuracy due to the saturation of the signal value.

### Fourth Embodiment

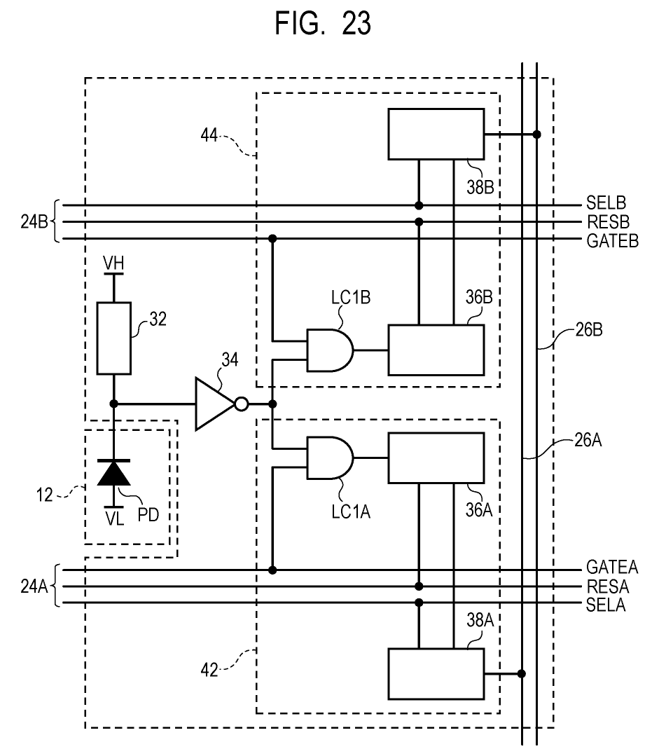

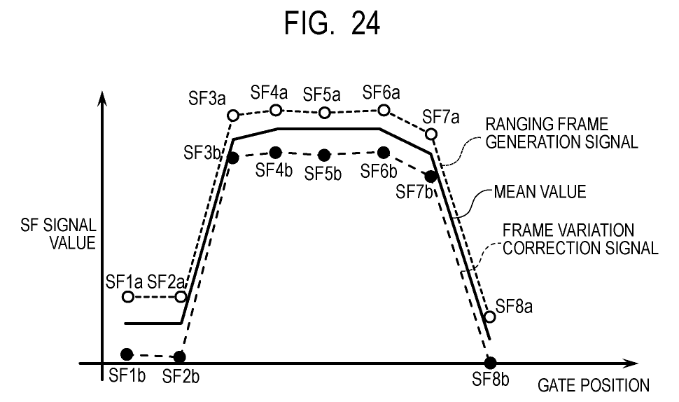

A ranging system according to a fourth embodiment will be described with reference to FIGS. 23 and 24. The same components as those of the ranging systems according to the first to third embodiments are denoted by the same reference numerals, and description thereof will be omitted or simplified.

As described with reference to FIG. 6, the pixel 30 includes two sets of the gating circuit LC1, the MF holding unit 36, and the selection circuit 38 for one set of the photoelectric conversion element PD, the quenching element 32, and the waveform shaping unit 34. By configuring the pixel 30 in this manner, it is possible to acquire two kinds of signals having different exposure periods based on the output signal from one photoelectric conversion element PD. In the present embodiment, an example in which a signal for generating a ranging frame and a signal for correcting a frame variation are acquired based on these two types of signals will be described.

In the present embodiment, for convenience, a circuit block including the gating circuit LC1A, the MF holding unit 36A, and the selection circuit 38A among the constituent elements of the pixel 30 is referred to as a ranging frame generation circuit unit 42. Among the constituent elements of the pixel 30, a circuit block including the gating circuit LC1B, the MF holding unit 36B, and the selection circuit 38B is referred to as a frame variation calculation circuit 44.

The ranging frame generation circuit unit 42 acquires the signal value of the sub-frame SF necessary for distance image generation according to the flowchart of, e.g., FIG. 11. On the other hand, at the same time, the frame variation calculation circuit 44 acquires the signal value of the sub-frame SF in a gating period different from the gating period set in the ranging frame generation circuit unit 42 (for example, one gating period ahead). Similarly, the signal values of the sub-frames SF in all the gating periods are acquired by the ranging frame generation circuit unit 42 and the frame variation calculation circuit 44. By performing such control, two signal values at different times may be obtained in each of the gating periods.

After the acquisition of the signal values of the sub-frames SF in all the gating periods is completed, the determination unit 140 reads out the signal value of the sub-frame SF in each gating period stored in the SF storage unit 172. Then, the determination unit 140 calculates an average value of two signal values in each gating period acquired at different times. FIG. 24 is a diagram illustrating an example of a ranging frame generation signal, a frame variation correction signal, and an average value thereof at each gate position. Although an example in which the average value is used as the method of correcting the frame variation is described here, the method of correcting the frame variation is not limited thereto. Although the frame variation correction is performed using the signal values of the sub-frames acquired at two different times, the frame variation correction may be performed using the signal values of the sub-frames acquired at three or more different times.

The determination unit 140 generates the low sensitivity mode shift signal and the normal mode shift signal based on the calculated average value. For example, in a case where the determination unit 140 has the configuration of FIG. 12, the calculated average value is input to the maximum signal value calculation circuit 144 and the minimum signal value calculation circuit 146, and in a case where the determination unit 140 has the configuration of FIG. 14, the calculated average value is input to the median value calculation circuit 142.

In the present embodiment, by outputting a plurality of types of signals having different gating periods from each pixel 30 at the same time and calculating the average value of the signal values for each gating period, the amount of blur in the time direction of the signal value of the sub-frame SF is corrected. As a result, since the accuracy of the signal value of the sub-frame SF is improved, the accuracy of the distance image generated from the signal value of the sub-frame SF is also improved, and consequently, the distance measurement accuracy may be improved.

As described above, according to the present embodiment, in the time gate type ranging device, since the saturation determination is performed based on the signal values of the sub-frames and the result is fed back to the operation condition, it is possible to suppress the deterioration of the ranging accuracy due to the saturation of the signal value.

### Fifth Embodiment

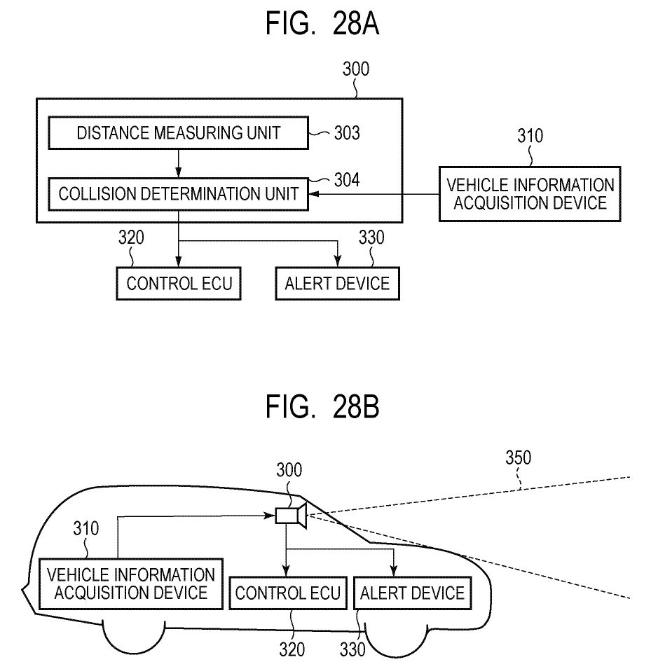

A movable object according to the fifth embodiment will be described with reference to FIGS. 28A and 28B. FIG. 28A is a diagram illustrating a configuration example of an equipment according to the present embodiment. FIG. 28B is a diagram illustrating a configuration example of a movable object according to the present embodiment.

FIG. 28A illustrates a configuration example of an equipment mounted on a vehicle as an on-vehicle camera. The equipment 300 includes a distance measuring unit 303 that measures a distance to an object, and a collision determination unit 304 that determines whether there is a possibility of collision based on the distance measured by the distance measuring unit 303. The distance measuring unit 303 is constituted by the ranging device 100 described in any of the first to fourth embodiments. Here, the distance measuring unit 303 is an example of a distance information acquisition unit that acquires distance information to the object. That is, the distance information is information related to a distance to the object or the like.

The equipment 300 is connected to the vehicle information acquisition device 310, and may acquire vehicle information such as a vehicle speed, a yaw rate, and a steering angle. In addition, a control ECU 320, which is a control device that outputs a control signal for generating a braking force to the vehicle based on the determination result of the collision determination unit 304, is connected to the equipment 300. The equipment 300 is also connected to an alert device 330 that issues an alert to the driver based on the determination result of the collision determination unit 304. For example, when the determination result of the collision determination unit 304 indicates that the possibility of collision is high, the control ECU 320 performs vehicle control to avoid collision and reduce damage by applying a brake, returning an accelerator, suppressing engine output, or the like. The alert device 330 gives an alert to the user by sounding an alarm such as a sound, displaying alert information on a screen of a car navigation system or the like, giving vibration to a seat belt or a steering wheel, or the like. These devices of the equipment 300 function as a movable object control unit that controls the operation of controlling the vehicle as described above.

In the present embodiment, the distance to the surroundings of the vehicle, for example, the front or the rear is measured by the equipment 300. FIG. 28B illustrates an equipment configured to measure in front of the vehicle (distance measurement range 350). The vehicle information acquisition device 310 serving as the distance measurement control unit sends an instruction to the equipment 300 or the distance measuring unit 303 to perform the ranging operation. With such a configuration, the accuracy of distance measurement may be further improved.

Although an example in which control is performed so as not to collide with another vehicle has been described above, the present embodiment is also applicable to control in which automatic driving is performed so as to follow another vehicle, control in which automatic driving is performed so as not to protrude from a lane, and the like. Furthermore, the equipment is not limited to vehicles such as automobiles, and may be applied to, for example, ships, aircrafts, artificial satellites, industrial robots, consumer robots, and the like movable objects (mobile devices). In addition, the present embodiment is not limited to the movable object and may be widely applied to equipment utilizing object recognition or biological recognition, such as intelligent transport systems (ITS), monitoring systems, and the like.

### Modified Embodiments

The present disclosure is not limited to the above embodiments, and various modifications are possible.

For example, an example in which a part of the configuration of any of the embodiments is added to another embodiment or an example in which a part of the configurations of any of the embodiments is substituted with some of the configurations of another embodiment is also an embodiment of the present disclosure.

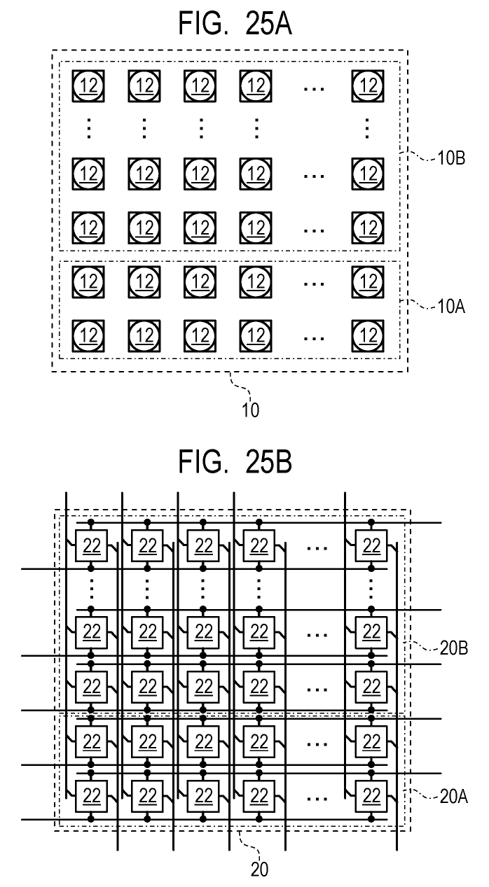

In addition, in the first to fourth embodiments, the determination processing in the determination unit 140 is performed for the signals of all the pixels 30, but it is not always necessary to perform the determination processing for the signals of all the pixels 30, and the determination processing may be performed for the signals of a part of the pixels 30. For example, it is assumed that pixel regions 10A and 10B divided into units of rows are defined in the pixel region 10 as illustrated in FIG. 25A, and pixel circuit regions 20A and 20B corresponding thereto are defined in the pixel circuit region 20 as illustrated in FIG. 25B. Then, the determination processing may be performed on the pixels 30 corresponding to the pixel region 10A and the pixel circuit region 20A, and the determination processing may not be performed on the pixels 30 corresponding to the pixel region 10B and the pixel circuit region 20B. The method of dividing the pixel region 10 and the pixel circuit region 20 is not particularly limited.

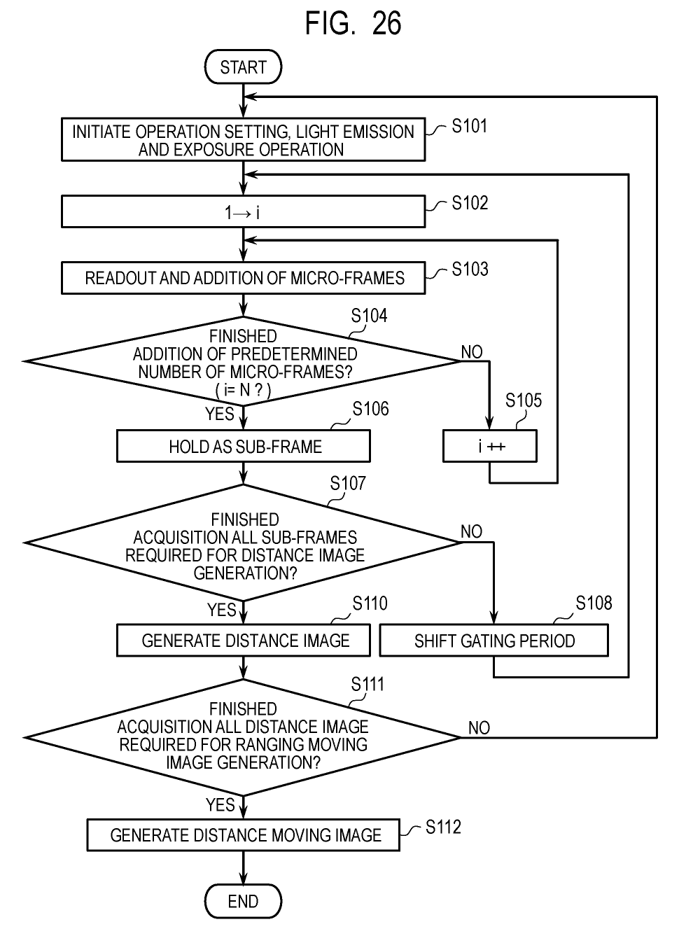

In this case, the pixels 30 corresponding to the pixel region 10A and the pixel circuit region 20A may be driven according to the flowchart of FIG. 11, for example, and the pixels 30 corresponding to the pixel region 10B and the pixel circuit region 20B may be driven according to the flowchart of FIG. 26, for example. The flowchart of FIG. 26 differs from the flowchart of FIG. 11 in that the operations in steps S110 and S112 are changed in connection with that step S109 is not performed. That is, in step S110 of FIG. 11, the distance image to which the determination attribute is added is generated, whereas in step S110 of FIG. 26, the determination attribute is not added in generating the distance image. In step S112 of FIG. 11, the distance image is replaced according to the determination result, whereas in step S112 of FIG. 26, the distance image is not replaced. Other points of the flowchart of FIG. 26 are the same as those of the flowchart of FIG. 11.

The photodetection device 120 does not necessarily need to be configured to output a signal for each pixel 30. For example, the photodetection device 120 may include a plurality of pixel blocks each including two or more pixels 30 and may be configured to output a signal for each pixel block. In this case, the signal output from each of the plurality of pixel blocks may be a signal obtained by adding the signals of the plurality of pixels 30 included in each of the plurality of pixel blocks.

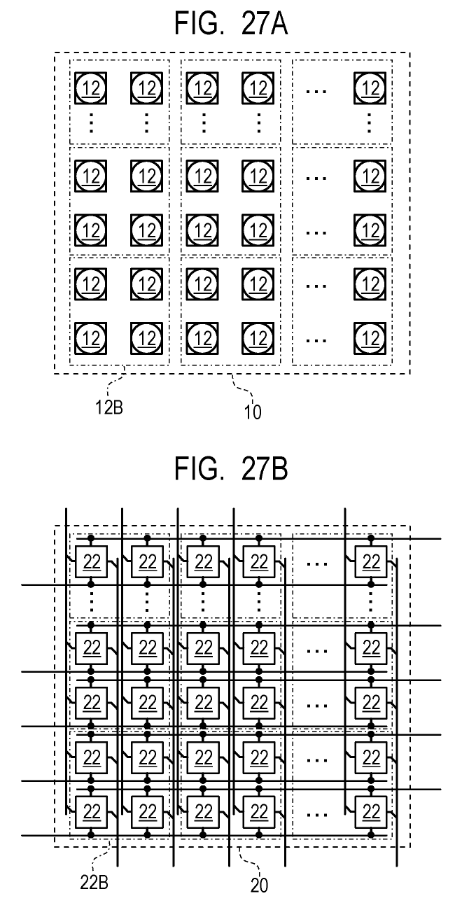

FIGS. 27A and 27B are schematic diagrams illustrating a case where one pixel block is configured by a photoelectric conversion block 12B including four photoelectric conversion units 12 arranged in two rows × two columns and a pixel circuit block 22B including four pixel signal processing units 22 arranged in two rows × two columns. In this case, for each pixel block, four micro-frames each constituted by one bit are output as one added micro-frame constituted by four bits.

In the first to fourth embodiments, the light source device 110 and the photodetection device 120 are described as a part of the components of the ranging device 100, but at least one of the light source device 110 and the photodetection device 120 does not necessarily need to be a part of the configuration of the ranging device 100.

Although the ranging device has been described in the first to fourth embodiments, the algorithm described in the above embodiments may also be applied to an information processing device for processing a signal output from the photodetection device 120. In this case, the information processing device may be provided with an input unit to which a signal is input and a signal processing unit. Here, the signal processing unit may include constituent elements other than the light source device 110 and the photodetection device 120 among the constituent elements of the ranging device 100. The information processing device may be a device such as a personal computer including a processor (for example, a CPU or an MPU). Alternatively, the information processing device may be a circuit such as an ASIC that realizes functions of an input unit to which a signal is input and a signal processing unit.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-070335, filed Apr. 22, 2025, which is hereby incorporated by reference herein in its entirety.

What is claimed is:

1. A ranging device comprising:
a light receiving unit that outputs a micro-frame having a one-bit signal indicating presence or absence of incident light at a predetermined timing to a photoelectric conversion element;
an addition unit that adds signal values of a plurality of the micro-frames output from the light receiving unit each for micro-frames that are based on the incident light at a same timing, and to generate a plurality of sub-frames each having a multi-bit signal acquired by adding signal values of two or more of the micro-frames;
a determination unit that performs a determination to change or not change an operation condition of the light receiving unit or the addition unit based on signal values of the plurality of sub-frames; and
a control unit configured to control the operation condition according to a determination result by the determination unit.

2. The ranging device according to claim 1, further comprising: a sub-frame storage unit that stores the plurality of sub-frames,
wherein the determination unit performs the determination using the plurality of sub-frames read out from the sub-frame storage unit.

3. The ranging device according to claim 1, wherein when the control unit sets the operation condition to a first sensitivity when it is determined that a maximum value of the signal values of the plurality of sub-frames is equal to or larger than a first threshold value or the control unit sets the operation condition to a second sensitivity lower than the first sensitivity when it is determined that a minimum value of the signal values of the plurality of sub-frames is equal to or larger than a second threshold value.

4. The ranging device according to claim 3,
wherein the first threshold value is a saturation determination value of the sub-frame, and
wherein the second threshold value is a value smaller than an intermediate value of signal values that the sub-frames are enabled to take.

5. The ranging device according to claim 1, wherein when the operation condition is set to a second sensitivity when it is determined that a maximum value of the signal values of the plurality of sub-frames is less than a third threshold value and a minimum value of the signal values of the plurality of sub-frames is less than a fourth threshold value, the control unit sets the operation condition to a first sensitivity higher than the second sensitivity.

6. The ranging device according to claim 5,
wherein the third threshold value is a value smaller than an intermediate value of signal values that the sub-frames are enabled to take, and
wherein the fourth threshold value is a value smaller than the third threshold value.

7. The ranging device according to claim 3, wherein the number of the micro-frames added to acquire each of the plurality of sub-frames at the first sensitivity is larger than the number of the micro-frames added to acquire each of the plurality of sub-frames at the second sensitivity.

8. The ranging device according to claim 3, wherein a pulse width of a pulse signal for driving the light receiving unit at a time of acquiring the sub-frames at the first sensitivity is wider than a pulse width of the pulse signal at the second sensitivity.

9. The ranging device according to claim 3, wherein the number of pulses of a pulse signal for driving the light receiving unit at a time of acquiring the sub-frame at the first sensitivity is larger than the number of pulses of the pulse signal at the second sensitivity.

10. The ranging device according to claim 3, wherein an absolute value of a drive voltage of the photoelectric conversion element at the first sensitivity is larger than an absolute value of the drive voltage of the photoelectric conversion element at the second sensitivity.

11. The ranging device according to claim 3,
wherein the light receiving unit includes a plurality of pixels each including the photoelectric conversion element,
wherein the addition unit generates the plurality of sub-frames for each of the plurality of pixels, and
wherein the determination unit acquires a median value at each gate position of each of the plurality of sub-frames of a determination target pixel and pixels adjacent around the determination target pixel, and to perform the determination using a maximum value among the acquired median values.

12. The ranging device according to claim 1,
wherein the light receiving unit includes a plurality of pixels each including the photoelectric conversion element,
wherein the plurality of pixels constitutes a plurality of pixel blocks each including two or more pixels, and
wherein the addition unit generates the plurality of sub-frames for each of the plurality of pixel blocks.

13. The ranging device according to claim 1, wherein a signal value of each of the plurality of sub-frames is an average value of signal values of two or more sub-frames acquired at different times.

14. The ranging device according to claim 1, wherein the predetermined timing is a predetermined gating period after a predetermined time elapses from a light emission of a light emitting unit.

15. The ranging device according to claim 1, wherein the light receiving unit includes a plurality of micro-frame holding units configured to hold a plurality of the micro-frames acquired by detecting output signals of one photoelectric conversion element at different timings.

16. The ranging device according to claim 1,
wherein the light receiving unit is configured to detect light emitted from a light emitting unit and reflected by an object in a measurement target region, and
wherein the ranging device acquires distance information to the object based on the signal values of the plurality of sub-frames.

17. A movable object comprising:
the ranging device according to claim 1; and
a control device configured to control the movable object based on distance information acquired by the ranging device.

18. An information processing device comprising:
an input unit that receives a micro-frame having a one-bit signal indicating presence or absence of incident light on a light receiving unit at a predetermined timing;
an addition unit that adds signal values of a plurality of the micro-frames input to the input unit each for micro-frames that are based on the incident light at a same predetermined timing, and to generate a plurality of sub-frames each having a multi-bit signal acquired by adding signal values of two or more of the micro-frames;
a determination unit that performs a determination to change an operation condition of the light receiving unit or the addition unit based on signal values of the plurality of sub-frames; and
a control unit configured to control the operation condition according to a determination result by the determination unit.

19. A ranging method comprising:
acquiring a micro-frame having a one-bit signal indicating presence or absence of incident light to a light receiving unit at a predetermined timing a plurality of times while changing the predetermined timing;
adding acquired signal values of a plurality of the micro-frames each for micro-frames that are based on the incident light at a same timing and generating a plurality of sub-frames each having a multi-bit signal acquired by adding signal values of two or more of the micro-frames;
performing a determination to change or not change an operation condition of the light receiving unit or the addition unit based on the signal values of the plurality of sub-frames; and
controlling the operation condition based on a result of the determination.
